(19) United States
(12) Patent Application Publication
(10) Pub. No.: US 2026/0322462 A1
(43) Pub. Date: Oct. 15, 2026

(54) COMMUNICATION METHODS AND APPARATUSES, COMMUNICATION DEVICE, COMMUNICATION SYSTEM AND STORAGE MEDIUM

(71) Applicant: Beijing Xiaomi Mobile Software Co., Ltd., Beijing (CN)

(72) Inventor: Min LIU, Beijing (CN)

(73) Assignee: Beijing Xiaomi Mobile Software Co., Ltd., Beijing (CN)

(21) Appl. No.: 19/482,525

(22) PCT Filed: May 11, 2023
(86) PCT No.: PCT/CN2023/093721

§ 371 Date: Nov. 7, 2025

(51) Int. Cl. H04B 7/06; H04L 5/00; H04W 72/0446; H04W 72/0453; H04W 72/231; H04W 76/20

(52) U.S. Cl. CPC H04B 7/0658; H04B 7/0626; H04L 5/0051; H04W 72/0446; H04W 72/0453; H04W 72/231; H04W 76/20

(57) ABSTRACT

The present disclosure provides communication methods and apparatuses, and a storage medium. A communication method executed by a terminal includes: receiving first information, the first information being used for instructing the terminal to send a first parameter multiple times, and the first parameter being used for evaluating the performance of a channel state information (CSI) compression model; and sending the first parameter multiple times.

### CROSS-REFERENCE TO RELATED APPLICATIONS

The present application is a U.S. National Stage of International Application No. PCT/CN2023/093721, filed on May 11, 2023, the content of which is incorporated by reference herein in its entirety for all purposes.

### TECHNICAL FIELD

The present disclosure relates to the field of communication technologies, and in particular to a communication method and a communication apparatus, a communication device, a communication system, and a storage media.

### BACKGROUND

During the process of sending channel state information (CSI) from a terminal to a network device, a CSI compression model can be used. This CSI compression model includes an encoder and a decoder, with the encoder deployed in the terminal and the decoder deployed in the network device. The terminal measures the downlink reference signal to obtain complete channel information, preprocesses this complete channel information, encodes the preprocessed information using the encoder, and sends the encoded information to the network device. Upon receiving the encoded information, the network device decodes it using the decoder to obtain the complete channel information.

### SUMMARY

The embodiments of the present disclosure provide a communication method and a communication apparatus, a communication device, a communication system, and a storage medium.

According to a first aspect of the embodiments of the present disclosure, there is provided a communication method, performed by a terminal, including:
receiving first information, the first information instructing the terminal to send a first parameter multiple times, the first parameter being configured to evaluate performance of a channel state information CSI compression model; and
sending the first parameter multiple times.

According to a second aspect of the embodiments of the present disclosure, there is provided a communication method, performed by a network device, including:
sending first information, the first information instructing a terminal to send a first parameter multiple times, the first parameter being configured to evaluate performance of a channel state information CSI compression model; and
receiving the first parameter multiple times.

According to a third aspect of the embodiments of the present disclosure, there is provided a communication method for a communication system, including:
a network device sending first information, the first information instructing a terminal to send a first parameter multiple times, the first parameter being configured to evaluate performance of a channel state information CSI compression model;
a terminal receiving first information, the first information instructing the terminal to send the first parameter multiple times, the first parameter being configured to evaluate the performance of the channel state information CSI compression model;
the terminal sending the first parameter multiple times; and
the network device receiving the first parameter multiple times.

According to a fourth aspect of the embodiments of the present disclosure, there is provided a first communication device, including a transceiver module configured to support the communication device to communicate.

When steps of the above first aspect are performed, the transceiver module is configured to:
receive first information, where the first information instructs a terminal to send a first parameter multiple times, and the first parameter is configured to evaluate performance of a channel state information CSI compression model; and
send the first parameter multiple times.

According to a fifth aspect of the embodiments of the present disclosure, there is provided a second communication device, including a transceiver module configured to support the communication device to communicate.

When steps of the above second aspect are performed, the transceiver module is configured to:
send first information, where the first information instructs a terminal to send a first parameter multiple times, and the first parameter is configured to evaluate performance of a channel state information CSI compression model; and
send the first parameter multiple times.

According to a sixth aspect of the embodiments of the present disclosure, there is provided a communication device, including a processor and a memory, where the processor is configured to invoke instructions to cause the communication device to perform the method according to the first aspect or the second aspect.

According to a seventh aspect of the embodiments of the present disclosure, there is provided a communication system, including a terminal and a network device, where the terminal is configured to implement the communication method according to the first aspect, and the access network device is configured to implement the communication method according to the second aspect.

According to an eighth aspect of the embodiments of the present disclosure, there is provided a non-transitory storage medium storing instructions, where when the instructions are executed on a communication device, the communication device performs the method according to the first aspect or the second aspect.

It is to be understood that the foregoing general description and the following detailed description are exemplary and explanatory only and are not restrictive of the disclosure.

### BRIEF DESCRIPTION OF THE DRAWINGS

To more clearly illustrate the technical solutions in the embodiments of the present disclosure, the following figures are necessary for describing the embodiments. The following figures merely illustrate some embodiments of the present disclosure and do not specifically limit the scope of protection of the present disclosure.

FIG. 1 is a schematic diagram of an architecture of a communication system according to an embodiment of the present disclosure.

FIG. 2 is a schematic diagram of interactions in a communication method according to an embodiment of the present disclosure.

FIG. 3A to FIG. 3F are flow charts of a communication method according to an embodiment of the present disclosure;

FIG. 4A to FIG. 4E are flow charts of a communication method according to an embodiment of the present disclosure;

FIG. 5 is a schematic diagram of interactions in a communication method according to an embodiment of the present disclosure;

FIG. 6 is a flow chart of a communication method according to an embodiment of the present disclosure;

FIG. 7A to FIG. 7B are schematic diagrams of a communication device according to an embodiment of the present disclosure;

FIG. 8A to FIG. 8B are schematic diagrams of a communication device according to an embodiment of the present disclosure.

### DETAILED DESCRIPTION

Embodiments of the present disclosure provide a communication method and a communication apparatus, a communication device, a communication system, and a storage medium.

In a first aspect, embodiments of the present disclosure provide a communication method, performed by a terminal, including:
receiving first information, the first information instructing the terminal to send a first parameter multiple times, the first parameter being configured to evaluate the performance of a CSI compression model; and
sending the first parameter multiple times.

In the above embodiment, by using a single first information to trigger the transmission of the first parameter multiple times, the requirement for using multiple first parameters when determining the performance of the CSI compression model can be met. Furthermore, compared to a semi-persistent activation and deactivation transmission method, signaling resources can be saved.

In conjunction with some embodiments of the first aspect, in some embodiments, the method further includes:
receiving second information, the second information including at least one of the following:
information indicating the number of transmissions;
information indicating a timer;
information indicating a quantization method, the quantization method being configured to quantize the first parameter;
information indicating a transmission mode, the transmission mode being a first mode or a second mode, the first mode corresponding to wideband measurement and the second mode corresponding to subband measurement;
information indicating a time domain interval, the time domain interval being a time domain interval between two consecutive transmissions of the first parameter;
information indicating a subband identifier; or
information indicating the first parameter.

In the above embodiment, the new function to be implemented is to trigger multiple transmissions of the first parameter using a single first information, and parameters required to implement the new function are set. This ensures that the new function adheres to parameter constraints while meeting diverse requirements across different aspects. This facilitates flexible configuration of the new function in different aspects, thereby enhancing its adaptability and controllability.

In the above embodiment, at least one of the following can be implemented:
the terminal performs transmission according to the number of transmissions indicated in the second information, accurately meeting the number of CSIs required by the network device to monitor the performance of the CSI compression model;
the terminal performs transmission according to the timer indicated in the second information and terminates transmission when the timer expires, ensuring that the CSI transmission required by the network device to monitor the performance of the CSI compression model is completed within the indicated time;
the terminal performs transmission according to the timer and the number of transmissions indicated in the second information, thereby reducing unnecessary transmission and saving uplink resources;
the terminal quantizes the first parameter according to the quantization method indicated in the second information, meeting the requirement of the network device for the quantization method, and sends the first parameter required by the network device;
the terminal sends the first parameters for different frequency band scales according to the transmission method indicated in the second information, meeting the requirement of the network device to use the first parameters for different frequency band scales to monitor the performance of the CSI compression model; or
the terminal sends the first parameter for the corresponding subband according to the indication in the second information, meeting the requirement of the network device to use the first parameter for a specific subband to monitor the performance of the CSI compression model.

In conjunction with some embodiments of the first aspect, in some embodiments, the method includes:
receiving third information, where the third information includes information indicating a time-frequency resource and a period of a downlink reference signal, the downlink reference signal is used for channel measurement; determining multiple timings based on the time-frequency resource and the period of the downlink reference signal, the timings being timings for receiving the downlink reference signal.

In the above embodiment, the timing for receiving the downlink reference signal can be determined, and the terminal can apply it as needed.

In conjunction with some embodiments of the first aspect, in some embodiments, the third information includes information indicating enabling a time limit for channel measurement; the first parameter is determined based on one of the multiple timings, where the one timing is earlier than a first time and is closest to the first time among the multiple timings, the first time is the time for sending the first parameter.

In the above embodiment, when the time limit for the channel measurement is enabled, computational power consumption required to determine the first parameter is reduced.

In conjunction with some embodiments of the first aspect, in some embodiments, the third information includes information indicating disabling the time limit for the channel measurement; the first parameter is determined based on the multiple timings, or the first parameter is determined based on one of the multiple timings; where the one timing is earlier than a first time and is closest to the first time among the multiple timings, and the first time is the time for sending the first parameter.

In the above embodiment, when the time limit for the channel measurement is disabled, the methods for determining the first parameter are diversified, and different methods can be used to improve the accuracy of the first parameter or reduce the computational power consumption required to determine the first parameter.

In conjunction with some embodiments of the first aspect, in some embodiments, the method includes:
receiving fourth information, the fourth information being used to configure a CSI reference resource;
the one timing is no later than the CSI reference resource.

In the above embodiment, in a case where the CSI reference resource is configured, it is ensured that there is no conflict between the one timing and the CSI reference resource.

In conjunction with some embodiments of the first aspect, in some embodiments, the method includes sending the first parameter multiple times, including sending the first parameter multiple times according to the period in a case where the second information does not include the information indicating the time domain interval.

In the above embodiment, utilizing the period of the downlink reference signal can save signaling resources.

In conjunction with some embodiments of the first aspect, in some embodiments, receiving the first information includes:
receiving the first information while the downlink reference signal is in an active state, where the downlink reference signal is used for channel measurement and is semi-persistent.

In the above embodiment, a situation in which the UE is unable to perform channel measurement due to receiving the first information in an inactive state is avoided.

In conjunction with some embodiments of the first aspect, in some embodiments, the interval between a first time and a second time is greater than a first duration, and the interval between the first time and a third time is greater than a second duration, the first time is a time for sending the first parameter, the second time is an end time for receiving the first information, the third time is an end time of the downlink reference signal, and the downlink reference signal is used for channel measurement.

In the above embodiment, by ensuring the interval between different time points, the required processing delay is met, ensuring the smooth completion of the corresponding processing, and avoiding processing failures due to insufficient processing delay.

In conjunction with some embodiments of the first aspect, in some embodiments, the first duration is greater than or equal to the processing delay for decoding downlink control information (DCI) and preparing the physical uplink shared channel (PUSCH), and the second duration is greater than or equal to the processing delay for calculating CSI.

In the above embodiments, the rationality of the first duration and the second duration is improved.

In conjunction with some embodiments of the first aspect, in some embodiments, different first parameters correspond to different processing delays.

In the above embodiments, increasing the flexibility of processing different first parameters can improve processing efficiency.

In conjunction with some embodiments of the first aspect, in some embodiments, receiving the first information includes receiving DCI, the DCI including the first information.

In the above embodiments, carrying the first information via the DCI improves reception flexibility.

In conjunction with some embodiments of the first aspect, in some embodiments, the first parameter includes at least one of the following:
ground-truth CSI; or
a second parameter indicating a degree of similarity.

In the above embodiments, the compatibility of the first parameter is improved.

In conjunction with some embodiments of the first aspect, in some embodiments, the second parameter includes at least one of the following:
a degree of similarity based on a CSI compression model, where the CSI compression model is in use;
a degree of similarity based on a CSI compression model that is not in use;
a degree of similarity of a codebook-based CSI processing method;
a square of generalized cosine similarity (SGCS);
a generalized cosine similarity (GCS); or
a normalized mean squared error (NMSE).

In the above embodiment, the compatibility of the second parameter is improved.

In a second aspect, embodiments of the present disclosure provide a communication method performed by a network device, the method including:
sending first information for instructing a terminal to send a first parameter multiple times, the first parameter being configured to evaluate the performance of a CSI compression model; and
receiving the first parameter multiple times.

In conjunction with some embodiments of the second aspect, in some embodiments, the method further includes:
sending second information, the second information including at least one of the following:
information indicating the number of transmissions;
information indicating a timer;
information indicating a quantization method, the quantization method being configured to quantize the first parameter;
information indicating a transmission mode, the transmission mode being a first mode or a second mode, the first mode corresponding to wideband measurement and the second mode corresponding to subband measurement;
information indicating a time domain interval, the time domain interval being a time domain interval between two consecutive transmissions of the first parameter;
information indicating a subband identifier; or
information indicating the first parameter.

In conjunction with some embodiments of the second aspect, in some embodiments, the method further includes:
sending third information, the third information including information indicating a time-frequency resource and a period of a downlink reference signal, the downlink reference signal being used for channel measurement;
the time-frequency resource and the period of the downlink reference signal are configured to determine multiple timings, and the timings are timings for receiving the downlink reference signal.

In conjunction with some embodiments of the second aspect, in some embodiments, the third information includes information indicating enabling a time limit for channel measurement; the first parameter is determined based on one of the multiple timings, where the one timing is earlier than a first time and is closest to the first time among the multiple timings, and the first time is the time for sending the first parameter.

In conjunction with some embodiments of the second aspect, in some embodiments, the third information includes information indicating disabling the time limit for the channel measurement; the first parameter is determined based on the multiple timings, or the first parameter is determined based on one of the multiple timings, where the one timing is earlier than a first time and is closest to the first time among the multiple timings, and the first time is the time for sending the first parameter.

In conjunction with some embodiments of the second aspect, in some embodiments, the method includes:
sending fourth information, the fourth information being used to configure a CSI reference resource;
the one timing is no later than the CSI reference resource.

In conjunction with some embodiments of the second aspect, in some embodiments, receiving the first parameter multiple times includes:
in a case where the second information does not include the information indicating the time domain interval, receiving the first parameter multiple times according to the period.

In conjunction with some embodiments of the second aspect, in some embodiments, sending the first information includes:
sending the first information while the downlink reference signal is in an active state, where the downlink reference signal is used for channel measurement and is semi-persistent.

In conjunction with some embodiments of the second aspect, in some embodiments, the interval between a first time and a second time is greater than a first duration, and the interval between the first time and a third time is greater than a second duration; the first time is a time for sending the first parameter, the second time is an end time for receiving the first information, the third time is an end time of the downlink reference signal, and the downlink reference signal is used for channel measurement.

In conjunction with some embodiments of the second aspect, in some embodiments, the first duration is greater than or equal to the processing delay for decoding DCI and preparing PUSCH, and the second duration is greater than or equal to the processing delay for calculating CSI.

In conjunction with some embodiments of the second aspect, in some embodiments, different first parameters correspond to different processing delays.

In conjunction with some embodiments of the second aspect, in some embodiments, sending the first information includes sending downlink control information DCI, where the DCI includes the first information.

In conjunction with some embodiments of the second aspect, in some embodiments, sending the second information includes:
sending Radio Link Control (RRC) information, the RRC information including the second information.

In conjunction with some embodiments of the second aspect, in some embodiments, the first parameter includes at least one of the following:
ground-truth CSI; or
a second parameter indicating a degree of similarity.

In conjunction with some embodiments of the second aspect, in some embodiments, the second parameter includes at least one of the following:
a degree of similarity based on a CSI compression model, where the CSI compression model is in use;
a degree of similarity based on a CSI compression model that is not in use;
a degree of similarity of a codebook-based CSI processing method;
a square of generalized cosine similarity (SGCS);
a generalized cosine similarity (GSC); or
a normalized mean square error (NMSE).

In a third aspect, embodiments of the present disclosure provide a communication method for use in a communication system, the method including:
a network device sends first information, the first information instructing a terminal to send a first parameter multiple times, the first parameter being configured to evaluate the performance of a CSI compression model;
a terminal receives the first information, the first information instructing the terminal to send the first parameter multiple times, the first parameter being configured to evaluate the performance of the CSI compression model;
the terminal sends the first parameter multiple times; and
the network device receives the first parameter multiple times.

In a fourth aspect, embodiments of the present disclosure provide a first communication device, which may include a transceiver module, where the transceiver module is configured to support the communication device to communicate. When performing the steps described in the first aspect, the transceiver module is configured to receive first information, where the first information instructs the terminal to send a first parameter multiple times, the first parameter is configured to evaluate the performance of a CSI compression model; and the transceiver module is configured to send the first parameter multiple times.

In a fifth aspect, embodiments of the present disclosure provide a second communication device, which may include a transceiver module, where the transceiver module is configured to support the communication device to communicate. When performing the steps described in the second aspect, the transceiver module is configured to send first information, where the first information instructs the terminal to send a first parameter multiple times, the first parameter is configured to evaluate the performance of a CSI compression model; and the transceiver module is configured to receive the first parameter multiple times.

In a sixth aspect, embodiments of the present disclosure provide a communication device, including a processor and a memory, where:
one or more processors;
where the processor is configured to invoke instructions to cause the communication device to perform the communication method described in the alternative implementation of the first aspect, or the communication method described in the alternative implementation of the second aspect.

In a seventh aspect, embodiments of the present disclosure provide a communication system, including a terminal and a network device, where the terminal is configured to implement the communication method as described in the alternative implementation of the first aspect, and the network device is configured to implement the communication method as described in the alternative implementation of the second aspect.

In an eighth aspect, embodiments of the present disclosure provide a storage medium storing instructions that, when executed on a communication device, cause the communication device to perform the method as described in the alternative implementation of the first or second aspect.

In a ninth aspect, embodiments of the present disclosure provide a program product that, when executed by a communication device, causes the communication device to perform the method as described in the alternative implementation of the first or second aspect.

In a tenth aspect, embodiments of the present disclosure provide a computer program that, when executed on a computer, causes the computer to perform the method as described in the alternative implementation of the first or second aspect.

It is understood that the first communication device, second communication device, the communication device, the communication system, the storage medium, the program product, and the computer program are all configured to perform the method provided by embodiments of the present disclosure. Therefore, the beneficial effects achievable by these methods can be referred to the beneficial effects of the corresponding methods and will not be further elaborated here.

Embodiments of the present disclosure provide a communication method, a communication device, and a readable storage medium. In some embodiments, the terms such as a communication method, a processing method, and an information processing method, etc. are interchangeable; the terms such as a communication device, a processing device, and an information processing device, etc. are interchangeable; and the terms such as a communication system, a processing system, and an information processing system, etc. are interchangeable.

The embodiments of the present disclosure are not exhaustive and are merely illustrative of some embodiments. They do not constitute a specific limitation on the scope of protection of the present disclosure. Unless otherwise specified, each step in an embodiment can be implemented as an independent embodiment, and the steps can be combined arbitrarily. For example, a solution with some steps removed from an embodiment can also be implemented as an independent embodiment. The order of the steps in an embodiment can be interchanged arbitrarily. Furthermore, the alternative implementations in an embodiment can be combined arbitrarily. Furthermore, the embodiments can be combined arbitrarily. For example, some or all steps in different embodiments can be combined arbitrarily, and one embodiment can be combined arbitrarily with the alternative implementations of other embodiments.

In the embodiments of the present disclosure, unless otherwise specified or logically conflicting, the terminology and/or descriptions between the embodiments are consistent and can be referenced. Technical features in different embodiments can be combined to form new embodiments based on their inherent logical relationships.

The terminology used in the embodiments of the present disclosure is for the purpose of describing specific embodiments only and is not intended to limit the present disclosure. In some embodiments, data, information, etc. may be obtained in accordance with the laws and regulations of the country of location.

In some embodiments, data, information, etc. may be obtained after obtaining user consent.

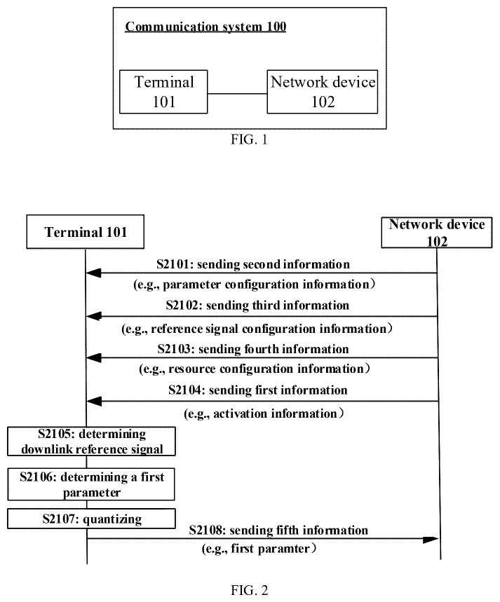

FIG. 1 is a schematic diagram illustrating the architecture of a communication system according to an embodiment of the present disclosure.

As shown in FIG. 1, the communication system 100 includes a terminal 101 and a network device 102.

In some embodiments, the terminal 101 includes, for example, at least one of a mobile phone, a wearable device, an Internet of Things device, a car with communication capabilities, a smart car, a tablet computer, a computer with wireless transceiver capabilities, a virtual reality (VR) terminal device, an augmented reality (AR) terminal device, a wireless terminal device used in industrial control, a wireless terminal device used in self-driving, a wireless terminal device used in remote medical surgery, a wireless terminal device used in smart grids, a wireless terminal device used in transportation safety, a wireless terminal device used in smart cities, and a wireless terminal device used in smart homes, but is not limited thereto.

In some embodiments, the network device 102 may include at least one of an access network device and a core network device.

In some embodiments, the access network device is, for example, a node or device that connects a terminal to a wireless network. The access network device may include, but is not limited to, at least one of an evolved NodeB (eNB), a next generation evolved NodeB (ng-eNB), a next generation NodeB (gNB), a NodeB (NB), a home nodeB (HNB), a home evolved nodeB (HeNB), wireless backhaul equipment, a radio network controller (RNC), a base station controller (BSC), a base transceiver station (BTS), a baseband unit (BBU), a mobile switching center, a base station in a 6G communication system, an open RAN, a cloud RAN, a base station in other communication systems, and an access node in a wireless fidelity (WiFi) system.

In some embodiments, the technical solutions of the present disclosure may be applied to the Open RAN architecture. In this case, the interfaces between or within access network devices involved in the embodiments of the present disclosure may become internal Open RAN interfaces, and the processes and information exchange between these internal interfaces may be implemented through software or programs.

In some embodiments, the access network device may consist of a central unit (CU) and a distributed unit (DU). The CU may also be called a control unit. A CU-DU architecture may be used to separate the protocol layers of the access network device, with functions of some protocol layers centrally controlled by the CU and functions of some or all of the remaining protocol layers distributed across the DU, which is then centrally controlled by the CU, but is not limited thereto.

In some embodiments, the core network device may be a single device including one or more network elements, or may be multiple devices or device clusters, each including all or part of one or more network elements. Network elements may be virtual or physical. The core network may, for example, include at least one of an evolved packet core (EPC), a 5G core network (5GCN), or a next-generation core (NGC).

It should be understood that the communication system described in the embodiments of the present disclosure is intended to more clearly illustrate the technical solutions of the embodiments of the present disclosure and does not constitute a limitation of the technical solutions provided by the embodiments of the present disclosure. Those skilled in the art will appreciate that, as system architectures evolve and new business scenarios emerge, the technical solutions provided by the embodiments of the present disclosure are equally applicable to similar technical problems.

The embodiments of the present disclosure described below may be applied to the communication system 100 shown in FIG. 1, or a portion thereof, but are not limited thereto. The entities shown in FIG. 1 are illustrative only. The communication system may include all or a portion of the entities shown in FIG. 1, or may include entities other than those shown in FIG. 1. The number and configuration of the entities are arbitrary, and the connections between the entities are illustrative only. The entities may be connected or disconnected, and the connections may be direct or indirect, wired or wireless.

The embodiments of the present disclosure can be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), future radio access (FRA), new radio access technology (RAT), new radio (NR), new radio access (NX), future generation radio access (FX), Global System for Mobile Communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), Public Land Mobile Network (PLMN) networks, Device-to-Device (D2D) systems, Machine-to-Machine (M2M) systems, Internet of Things (IoT) systems, Vehicle-to-Everything (V2X) systems, systems utilizing other communication methods, and next-generation systems based on these, etc. Furthermore, multiple systems may be combined (for example, a combination of LTE or LTE-A with 5G) for application.

In embodiments of the present disclosure, the terminal 101 sends quantized CSI to the network device 102.

In one example, the terminal 101 deploys an encoder for a CSI compression model. The encoder does not include a quantization module. The encoder outputs quantized CSI, and the terminal 101 sends the quantized CSI to the network device 102.

In another example, the terminal 101 deploys an encoder for a CSI compression model. The encoder does not include a quantization module. The terminal 101 quantizes the CSI output by the encoder and then sends quantized CSI to the network device 102.

In the embodiments of the present disclosure, since the performance of the CSI compression model may be limited by the training dataset, the CSI compression model may not be able to effectively compress the channel data in the current scenario. This results in the network device 102 being unable to obtain accurate CSI, further causing the network device 102 to use inappropriate transmission data, thereby degrading the system performance. The transmission data includes at least one of the following: a modulation and coding scheme (MCS) or a precoding matrix indicator (PMI). Therefore, it is necessary to monitor the performance of the CSI compression model to ensure that timely detection and appropriate action can be taken in a case where the performance of the CSI compression model does not meet requirements. The appropriate action may include using another CSI compression model or a traditional codebook-based CSI transmission method.

In the embodiments of the present disclosure, the performance of the CSI compression model is monitored by the terminal 101 or the network device 102. Two methods are described below:

First method, the performance of the CSI compression model is monitored by the terminal 101.

Alternatively, a proxy decoder is deployed in addition to the encoder in the terminal 101. The proxy decoder calculates performance parameters configured to evaluate the CSI compression model. The calculated performance parameters are sent to the network device 102. Upon receiving the performance parameters, the network device 102 performs appropriate processing, including using another CSI compression model or a traditional codebook-based CSI transmission method.

In one example, the performance parameter calculated by the proxy decoder for evaluating the CSI compression model is SGCS, which can be considered to be correlated with the SGCS measured by the decoder deployed in the network device 102.

Second method, the performance of the CSI compression model is monitored by the network device 102.

Alternatively, the terminal 101 measures the downlink reference signal to obtain ground-truth CSI, and sends the ground-truth CSI to the network device 102. A decoder in the network device 102 outputs CSI, and the network device 102 determines the similarity between the CSI and the ground-truth CSI, and evaluates the performance of the CSI compression model based on the similarity.

Alternatively, the CSI output by the decoder in the network device 102 may be channel matrix information or channel precoding information. If the CSI is channel precoding information, the precoding information is obtained by terminal 101 through preprocessing of the measured channel matrix information. The preprocessing may be one of the following:
performing singular value decomposition (SVD) on the channel matrix to obtain eigenvector information with a dimension equal to the number of transmit antennas in the network device 102; or
performing a further process on the eigenvector obtained after SVD decomposition, where the further process is mapping to the angle-delay domain through DFT transform.

Alternatively, the ground-truth CSI can also serve as input information for the encoder in the terminal 101.

In the embodiments of the present disclosure, considering that when monitoring the performance of the CSI compression model, monitoring at a single time is not stable enough, and monitoring over a period of time is more accurate, the terminal needs to send performance parameters multiple times.

In the embodiments of the present disclosure, considering that the transmission overhead of sending performance parameters is high, a periodic transmission method is not suitable. Since real-time monitoring of the performance of the CSI compression model is not required, monitoring can be initiated only when necessary. Therefore, multiple transmissions of performance parameters are not suitable for periodic transmission, and are more suitable for aperiodic transmission.

In the embodiments of the present disclosure, considering that multiple transmissions can be accomplished using a semi-persistent CSI transmission mechanism, each triggering process in the semi-persistent CSI transmission mechanism requires both activation and deactivation instructions. Using multiple triggering processes for multiple transmissions of performance parameters results in signaling waste, so aperiodic transmission is more suitable for sending performance parameters.

In the embodiments of the present disclosure, considering that a conventional aperiodic transmission method only sends information once after a trigger condition is met, resulting in low transmission efficiency. An alternative aperiodic transmission method can be employed, namely, sending information multiple times after a trigger condition is met, to improve transmission efficiency.

FIG. 2 is an interactive diagram illustrating a communication method according to an embodiment of the present disclosure. As shown in FIG. 2, the embodiments of the present disclosure relate to a communication method for a communication system 100. The method includes:
Step S2101: the network device 102 sends second information.

In some embodiments, the terminal 101 receives the second information.

In some embodiments, the names of information, etc., are not limited to those described in the embodiments. Terms such as “information”, “message”, “signal”, “signaling”, “report”, “configuration”, “indication”, “instruction”, “command”, “channel”, “parameter”, “domain”, “field”, “symbol”, “codebook”, “codeword”, “codepoint”, “bit”, “data”, “program”, and “chip”, etc. are interchangeable.

In some embodiments, the second information is used for CSI report configuration.

In some embodiments, the second information includes CSI report settings.

In some embodiments, the second information includes at least one of the following:
information indicating the number of transmissions;
information indicating a timer;
information indicating a quantization method, the quantization method being configured to quantize the first parameter;
information indicating a transmission mode, the transmission mode being a first mode or a second mode, the first mode corresponding to wideband measurement and the second mode corresponding to subband measurement;
information indicating a time domain interval, the time domain interval being a time domain interval between two consecutive transmissions of the first parameter;
information indicating a subband identifier; or
information indicating the first parameter.

In some embodiments, the start time of the timer is an end time for the terminal receiving the first information.

In some embodiments, the start time of the timer is a start time for the terminal first sending the first parameter.

In some embodiments, in a case where the second information includes the information indicating the transmission mode and the information indicating the subband identifier, the second information further includes information indicating a subband division mode.

Alternatively, the subband division mode includes a first number, and the first number is the number of resource blocks included in each subband.

In some embodiments, the network device 102 sends Radio Resource Control (RRC) Control (RRC) information, and the RRC information includes the second information.

In some embodiments, the terminal 101 receives the RRC information.
Step S2102: the network device 102 sends third information.

In some embodiments, the third information includes information indicating the time-frequency resource and the period of a downlink reference signal.

Alternatively, the downlink reference signal is used for channel measurement.

Alternatively, the time-frequency resource and the period of the downlink reference signal are used to determine multiple timings, each of which is a timing for receiving the downlink reference signal.

In some embodiments, the third information includes information indicating enabling a time limit for channel measurement.

In some embodiments, the third information includes information indicating disabling a time limit for channel measurement.

In some embodiments, the network device 102 sends RRC information, and the RRC information includes the third information.

In some embodiments, the terminal 101 receives the RRC information.
Step S2103: the network device 102 sends fourth information.

In some embodiments, the terminal 101 receives the fourth information.

In some embodiments, the fourth information is used to configure a CSI reference resource.

In some embodiments, the network device 102 sends RRC information, and the RRC information includes the fourth information.

In some embodiments, the terminal 101 receives the RRC information.
Step S2104: the network device 102 sends first information.

In some embodiments, the terminal 101 receives the first information.

In some embodiments, the first information is configured to instruct the terminal to send a first parameter multiple times, and the first parameter is configured to evaluate the performance of a CSI compression model.

In one example, the CSI compression model is based on artificial intelligence (AI).

In some embodiments, the first parameter includes at least one of the following:
ground-truth CSI; or
a second parameter indicating a degree of similarity.

Alternatively, the ground-truth CSI is a floating-point number or a first format similar to eType II.

Alternatively, the second parameter includes at least one of the following:
a degree of similarity based on a CSI compression model, where the CSI compression model is in use;
a degree of similarity based on a CSI compression model that is not in use;
a degree of similarity of a codebook-based CSI processing method;
a square of generalized cosine similarity (SGCS);
a generalized cosine similarity (GSC); or
a normalized mean square error (NMSE).

In some embodiments, the first information also indicates the first parameter.

In some embodiments, the terminal 101 learns that the first parameter is required based on the first information.

Alternatively, the first information also indicates the actual CSI.

Alternatively, the first information also indicates a second parameter.

In some embodiments, the network device 102 sends DCI, and the DCI includes the first information.

In some embodiments, the terminal 101 receives the DCI.

In some embodiments, the terms such as “down”, “downlink” and “physical downlink”, etc. are interchangeable, and the terms such as “side”, “sidelink”, “sidelink communication”, “direct connection”, “direct link”, “direct communication” and “direct link communication”, etc. are interchangeable.

In some embodiments, the terms such as “downlink control information (DCI)”, “downlink (DL) assignment”, “DL DCI”, “uplink (UL) grant” and “UL DCI” etc. are interchangeable.

In some embodiments, the network device 102 sends the first information when a downlink reference signal is in an activated state, where the downlink reference signal is used for channel measurement and is semi-persistent.

In some embodiments, the terminal 101 receives the first information when the downlink reference signal is in an activated state.

In some embodiments, the terminal 101 does not expect to receive the first information when the downlink reference signal is in an active state.

In some embodiments, the terminal 101 does not expect the downlink reference signal is in an inactive state when the terminal 101 receives the first information.
Step S2105: the terminal 101 determines the downlink reference signal.

In some embodiments, determining can be interpreted as calculating, computing, investigating, ascertaining, etc., but not limited thereto.

In some embodiments, the terminal 101 determines a downlink reference signal for starting measurement.

Alternatively, the terminal 101 determines the downlink reference signal for starting measurement as: the first downlink reference signal after a first duration after a first time. The first time is an end time of the first information, and the first duration is the time domain offset of the DCI.

In some embodiments, terms such as “time”, “time point”, “moment” and “time position”, etc. are interchangeable, and terms such as “duration”, “period”, “time window”, “window” and “time”, etc. are interchangeable.

In some embodiments, the downlink reference signal is a periodic downlink reference signal, or a semi-persistent downlink reference signal.

Alternatively, the time domain offset of the DCI is expressed in units of slots, subslots, or symbols.

In one example, the terminal 101 receives the first information in slot n, and the time domain offset of the DCI is x slots. The terminal 101 uses the first downlink reference signal for measurement after slot n+x as the downlink reference signal for starting measurement.

In some embodiments, terms such as “frame”, “radio frame”, “subframe”, “slot”, “sub-slot”, “mini-slot”, “symbol” and “transmission time interval (TTI)”, etc. are interchangeable.

In some embodiments, terms such as “synchronization signal (SS)”, “synchronization signal block (SSB)”, “reference signal (RS)”, “pilot” and “pilot signal”, etc. are interchangeable.
In step S2106, the terminal 101 determines the first parameter.

In some embodiments, if the third information indicates enabling the time limit for channel measurement, the first parameter is determined based on one of multiple timings.

The one timing is earlier than a first time and is closest to the first time among the multiple timings, and the first time is a time when the first parameter is sent.

Alternatively, if the terminal 101 has received the fourth information, the one timing is no later than the CSI reference resource.

In some embodiments, if the third information indicates disabling the time limit for channel measurement, the first parameter is determined based on the multiple timings, or the first parameter is determined based on one of the multiple timings.

The one timing is earlier than a first time and is closest to the first time among the multiple timings, and the first time is a time when the first parameter is sent.

Alternatively, if the terminal 101 has received the fourth information, the one timing is no later than the CSI reference resource.
Step S2107: the terminal 101 performs quantization.

In some embodiments, the terminal 101 quantizes the first parameter.

In some embodiments, the terminal 101 quantizes the first parameter using a first quantization method, and the first quantization method is a quantization method indicated in the second information. If the first parameter is the ground-truth CSI and the first quantization method is based on eType II, the UE quantizes the ground-truth CSI based on eType II and then sends it.

In some embodiments, the terminal 101 quantizes the first parameter using a second quantization method, and the second information does not include information indicating the quantization method.

Alternatively, the second quantization method is a predefined quantization method.
Step S2108: the terminal 101 sends fifth information.

In some embodiments, the network device 102 receives the fifth information.

In some embodiments, the terminal 101 sends the fifth information multiple times.

In some embodiments, the network device 102 receives the fifth information multiple times.

In some embodiments, the fifth information includes the first parameter.

Alternatively, the first parameter is quantized.

In some embodiments, the fifth information includes the first parameter and the range to which the first parameter belongs.

Alternatively, the range is one of multiple ranges.

Alternatively, the multiple ranges are multiple default ranges.

Alternatively, the multiple ranges are multiple preset ranges.

In some embodiments, the fifth information includes the first parameter and the corresponding level of the first parameter.

Alternatively, the level is one of multiple levels.

Alternatively, the multiple levels are multiple default levels.

Alternatively, the multiple levels are multiple preset levels.

For example, the multiple levels include three levels, corresponding to: low, medium, and high.

In some embodiments, if the second information includes information indicating the number of transmissions, the terminal 101 sends the first parameter at the number of transmissions.

In some embodiments, if the second information includes information indicating a timer, the terminal 101 sends the first parameter multiple times before the timer expires.

In some embodiments, if the second information includes information indicating the number of transmissions and information indicating a timer, the terminal 101 stops sending the first parameter when the timer expires and the number of times the first parameter has been sent is less than the number of transmissions.

In some embodiments, if the second information includes information indicating the number of transmissions and information indicating a timer, the terminal 101 stops sending the first parameter when the number of times the first parameter has been sent reaches the number of transmissions and the timer has not expired.

In some embodiments, if the second information includes information indicating a time domain interval, the terminal 101 receives the first parameter multiple times according to the time domain interval.

In some embodiments, if the second information does not include the information indicating the time domain interval, the terminal 101 sends the first parameter multiple times according to the period.

In some embodiments, if the second information does not include the information indicating the time domain interval, terminal 101 sends the first parameter multiple times according to the period.

Alternatively, if the second information does not include the information indicating the time domain interval and the second information includes information indicating the time-frequency resources and periods of multiple downlink reference signals, the terminal 101 sends the first parameter multiple times according to the period.

In some embodiments, if the information indicating the transmission mode included in the second information indicates the first mode, the first parameter is the first parameter after wideband measurement. If the information indicating the transmission mode included in the second information indicates the second mode, the first parameter is the first parameter after subband measurement.

In some embodiments, if the information indicating the transmission mode included in the second information indicates the second mode, the second information includes information indicating a subband identifier, and the first parameter is the first parameter after subband measurement corresponding to the identifier.

In some embodiments, the interval between a first time and a second time is greater than a first duration, and the interval between the first time and a third time is greater than a second duration. The first time is a time for sending the first parameter, the second time is an end time for receiving the first information, the third time is an end time of a downlink reference signal, and the downlink reference signal is used for channel measurement.

Alternatively, the first duration is greater than or equal to the processing delay for decoding the DCI and preparing the physical uplink shared channel (PUSCH), and the second duration is greater than or equal to the processing delay for calculating the CSI.

In some embodiments, different first parameters correspond to different processing delays.

In some embodiments, the terms such as “send”, “transmit” and “report”, etc. are interchangeable.

In some embodiments, at least one of steps S2101 to S2108 may be performed. For example, step S2108 can be implemented as an independent embodiment; step S2104+step S2108 can be implemented as an independent embodiment; step S2101+step S2104+step S2108 can be implemented as an independent embodiment; step S2012+step S2104+step S2103+step S2108 can be implemented as an independent embodiment; step S2101+step S2102+step S2104 +step S2108 can be implemented as an independent embodiment; and step S2101+step S2102+step S2103+step S2104+step S2108 can be implemented as an independent embodiment, which is not limited thereto.

In some embodiments, any two steps from step S2102 to step S2104 can be swapped in order or performed simultaneously.

In some embodiments, step S2101, step S2102, and step S2103 can be performed simultaneously.

In some embodiments, when steps S2101, S2102, and S2103 are performed simultaneously, the information in steps S2101, S2102, and S2103 is sent via the same signaling, for example, RRC signaling.

In some embodiments, steps S2101 to S2107 are optional, and one or more of these steps may be omitted or replaced in different embodiments.

In some embodiments, steps S2101 to S2103 and steps S2105 to S2107 are optional, and one or more of these steps may be omitted or replaced in different embodiments.

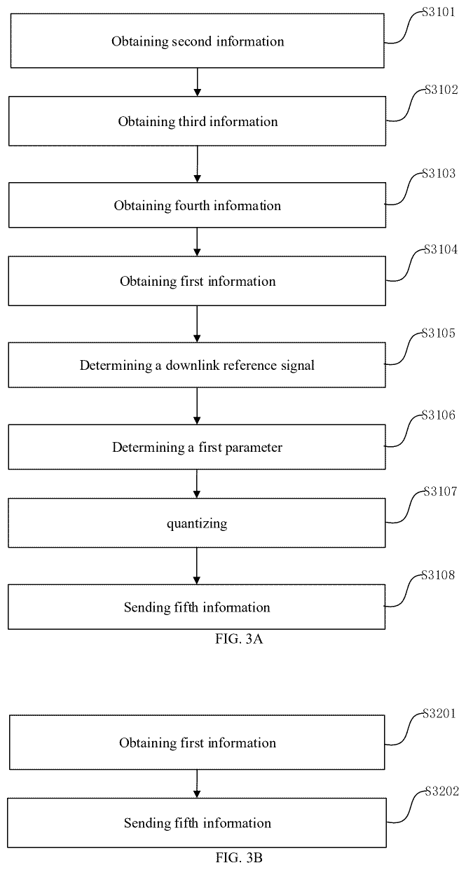

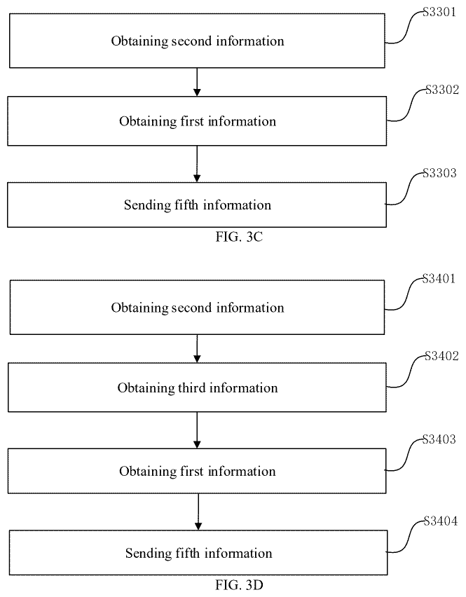

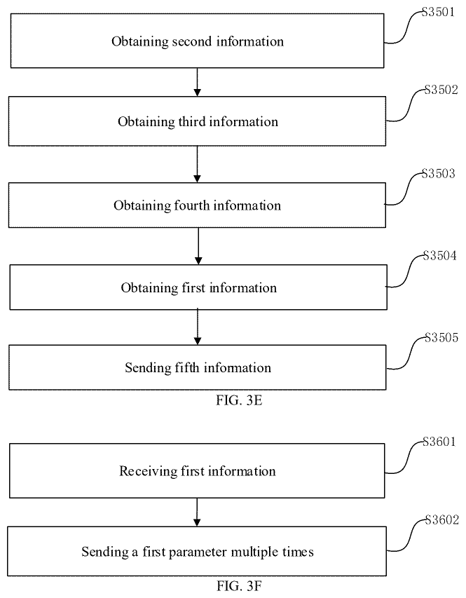

FIG. 3A is a flow diagram illustrating a communication method according to an embodiment of the present disclosure. As shown in FIG. 3A, the embodiment of the present disclosure relates to a communication method, performed by terminal 101, including:
Step S3101: obtaining second information.

Alternative implementations of step S3101 can be found in the alternative implementations of step S2101 in FIG. 2 and other related portions of the embodiments described in FIG. 2, and will not be further described here.

In some embodiments, the terminal 101 receives first information sent by the network device 102, which is not limited thereto, and the terminal 101 may also receive first information sent by other entities.

In some embodiments, the terminal 101 obtains first information specified by a protocol.

In some embodiments, the terminal 101 obtains the first information from an upper layer(s).

In some embodiments, the terminal 101 performs process to obtain the first information.

In some embodiments, step S3101 is omitted, and terminal 101 autonomously implements the function indicated by the first information, or the function is defaulted or set as default.

In some embodiments, “obtain”, “acquire”, “get”, “receive”, “transmit” and “send and/or receive”, etc. are interchangeable and can be interpreted as meaning various things, such as receiving from another entity, obtaining from a protocol, obtaining through self-processing, and autonomous implementation, etc.
Step S3102: obtaining third information.

Alternative implementations of step S3102 can be found in the alternative implementations of step S2102 in FIG. 2 and other related portions of the embodiments described in FIG. 2 and are not further described here.

In some embodiments, the terminal 101 receives second information sent by the network device 102, which is not limited thereto, and the terminal 101 may also receive second information sent by other entities.

In some embodiments, the terminal 101 obtains second information specified by a protocol.

In some embodiments, the terminal 101 obtains the second information from an upper layer(s).

In some embodiments, the terminal 101 perform process to obtain the second information.

In some embodiments, step S3101 is omitted, and the terminal 101 autonomously implements the function indicated by the second information, or the function is defaulted or set as default.
Step S3103: obtaining fourth information.

Alternative implementations of step S3103 can be found in the alternative implementations of step S2103 in FIG. 2 and other related portions of the embodiment described in FIG. 2, and are not further described here.

In some embodiments, the terminal 101 receives third information sent by the network device 102, which is not limited thereto, and the terminal 101 may also receive third information sent by other entities.

In some embodiments, the terminal 101 obtains third information specified by a protocol.

In some embodiments, the terminal 101 obtains the third information from an upper layer(s).

In some embodiments, the terminal 101 performs process to obtain the third information.

In some embodiments, step S3101 is omitted, and the terminal 101 autonomously implements the function indicated by the third information, or the function is defaulted or set as default.
Step S3104: obtaining first information.

Alternative implementations of step S3104 can be found in the alternative implementations of step S2104 in FIG. 2 and other related portions of the embodiment described in FIG. 2, and are not further described here.

In some embodiments, the terminal 101 receives fourth information sent by the network device 102, which is not limited thereto, and the terminal 101 may also receive fourth information sent by other entities.

In some embodiments, the terminal 101 obtains fourth information specified by a protocol.

In some embodiments, the terminal 101 obtains fourth information from an upper layer(s).

In some embodiments, the terminal 101 performs process to obtain the fourth information.

In some embodiments, step S3101 is omitted, and the terminal 101 autonomously implements the function indicated by the fourth information, or the function is defaulted or set as default.
Step S3105: determining a downlink reference signal.

Alternative implementations of step S3105 can be found in the alternative implementations of step S2105 in FIG. 2 and other related portions of the embodiments described in FIG. 2, and are not further described here.
Step S3106: determining a first parameter.

Alternative implementations of step S3106 can be found in the alternative implementations of step S2106 in FIG. 2 and other related portions of the embodiments described in FIG. 2, and are not further described here.
Step S3107: performing quantization.

Alternative implementations of step S3107 can be found in the alternative implementations of step S2107 in FIG. 2 and other related portions of the embodiments described in FIG. 2, and are not further described here.
Step S3108: sending the fifth information.

Alternative implementations of step S3108 can be found in the alternative implementations of step S2108 in FIG. 2 and other related portions of the embodiments described in FIG. 2, and are not further described here.

In some embodiments, at least one of steps S3101 to S3108 may be performed. For example, step S3108 can be implemented as an independent embodiment; step S3104+step S3108 can be implemented as an independent embodiment; step S3101+step S3104+step S3108 can be implemented as an independent embodiment; step S3101+step S3102+step S3104+step S3108 can be implemented as an independent embodiment; and step S3101+step S3102+step S3103+step S3104+step S3108 can be implemented as an independent embodiment, which is not limited thereto.

In some embodiments, any two steps from step S3101 to step S3104 can be swapped in order or performed simultaneously.

In some embodiments, step S3101, step S3102, and step S3103 can be performed simultaneously.

In some embodiments, when steps S3101, S3102, and S3103 are performed simultaneously, the information in steps S3101, S3102, and S3103 is sent via the same signaling, for example, RRC signaling.

In some embodiments, steps S3101 to S3107 are optional, and one or more of these steps may be omitted or replaced in different embodiments.

In some embodiments, steps S3101 to S3103 and steps S3105 to S3107 are optional, and one or more of these steps may be omitted or replaced in different embodiments.

FIG. 3B is a flow diagram illustrating a communication method according to an embodiment of the present disclosure. As shown in FIG. 3B, the embodiment of the present disclosure relates to a communication method, performed by the terminal 101, including:
Step S3201: obtaining first information.

Alternative implementations of step S3201 can be found in the alternative implementations of step S2104 in FIG. 2 and step S3104 in FIG. 3A and other related portions of the embodiments described in FIG. 2 and FIG. 3A, and will not be further described here.
Step S3202: sending the fifth information.

Alternative implementations of step S3202 can be found in the alternative implementations of step S2108 in FIG. 2 and step S3108 in FIG. 3A and other related portions of the embodiments described in FIG. 2 and FIG. 3A, and will not be further described here.

In some embodiments, at least one of steps S3201 and S3202 can be performed. For example, step S3202 can be implemented as an independent embodiment, but is not limited thereto.

In some embodiments, step S3201 is optional, and one or more of these steps can be omitted or replaced in different embodiments.

In the embodiments of the present disclosure, step S3202 can be combined with step S3101 in FIG. 3A; step S3202 can be combined with step S3102 in FIG. 3A; step S3202 can be combined with steps S3101 and S3102 in FIG. 3A; and step S3202 can be combined with step S3105 in FIG. 3A.

FIG. 3C is a flow chart illustrating a communication method according to an embodiment of the present disclosure. As shown in FIG. 3C, the embodiments of the present disclosure relate to a communication method, performed by the terminal 101, including:
Step S3301: obtaining second information.

Alternative implementations of step S3301 can be found in the alternative implementations of step S2101 in FIG. 2 and step S3101 in FIG. 3A and other related portions of the embodiments described in FIG. 2, FIG. 3A and FIG. 3B, and will not be further described here.
Step S3302: obtaining first information.

Alternative implementations of step S3302 can be found in the alternative implementations of step S2104 in FIG. 2 and step S3104 in FIG. 3A and other related portions of the embodiments described in FIG. 2 and FIG. 3A, and will not be further described here.
Step S3303: sending fifth information.

Alternative implementations of step S3303 can be found in the alternative implementations of step S2108 in FIG. 2 and step S3108 in FIG. 3A and other related portions of the embodiments described in FIG. 2, FIG. 3A and FIG. 3B, and will not be further described here.

In some embodiments, at least one of steps S3301 to S3303 can be performed. For example, step S3303 can be implemented as an independent embodiment; steps S3302 to S3303 can be implemented as an independent embodiment; however, it is not limited thereto.

In some embodiments, steps S3301 and S3302 are optional, and one or more of these steps may be omitted or replaced in different embodiments.

In the embodiments of the present disclosure, step S3303 can be combined with step S3102 in FIG. 3A; step S3303 can be combined with step S3103 in FIG. 3A; steps S3302 and S3303 can be combined with step S3105 in FIG. 3A; and steps S3301, S3302, and S3303 can be combined with steps S3105 and S3106 in FIG. 3A.

FIG. 3D is a flow chart illustrating a communication method according to an embodiment of the present disclosure. As shown in FIG. 3D, the embodiments of the present disclosure relate to a communication method performed by the terminal 101, including:
Step S3401: obtaining second information.

Alternative implementations of step S3401 can be found in the alternative implementations of step S2101 in FIG. 2 and step S3101 in FIG. 3A and other related portions of the embodiments described in FIG. 2 and FIG. 3A, and will not be further described here.
Step S3402: obtaining third information.

Alternative implementations of step S3402 can be found in the alternative implementations of step S2102 in FIG. 2 and step S3102 in FIG. 3A and other related portions of the embodiments described in FIG. 2 and FIG. 3A, and will not be further described here.
Step S3403: obtaining first information.

Alternative implementations of step S3403 can be found in the alternative implementations of step S2104 in FIG. 2 and step S3104 in FIG. 3A and other related portions of the embodiments described in FIG. 2 and FIG. 3A, and will not be further described here.
Step S3404: sending fifth information.

Alternative implementations of step S3404 can be found in the alternative implementations of step S2108 in FIG. 2 and step S3108 in FIG. 3A and other related portions of the embodiments described in FIG. 2 and FIG. 3A, and will not be further described here.

In some embodiments, at least one of steps S3401 to S3404 can be performed. For example, step S3404 can be implemented as an independent embodiment; steps S3403 and S3404 can be implemented as an independent embodiment; but the present disclosure is not limited thereto.

In some embodiments, steps S3401, S3402, and S3403 are optional, and one or more of these steps may be omitted or replaced in different embodiments.

In the embodiments of the present disclosure, step S3404 can be combined with step S3103 in FIG. 3A; steps S3401 and S3403 can be combined with step S3105 in FIG. 3A; and steps S3401, S3402, and S3403 can be combined with steps S3105 and S3106 in FIG. 3A.

FIG. 3E is a flow diagram illustrating a communication method according to an embodiment of the present disclosure. As shown in FIG. 3E, the embodiments of the present disclosure relate to a communication method performed by terminal 101, including:
Step S3501: obtaining second information.

Alternative implementations of step S3501 can be found in the alternative implementations of step S2101 in FIG. 2 and step S3101 in FIG. 3A and other related portions of the embodiments described in FIG. 2 and FIG. 3A, and will not be further described here.
Step S3502: obtaining third information.

Alternative implementations of step S3502 can be found in the alternative implementations of step S2102 in FIG. 2 and step S3102 in FIG. 3A and other related portions of the embodiments described in FIG. 2 and FIG. 3A, and will not be further described here.
Step S3503: obtaining fourth information.

Alternative implementations of step S3503 can be found in the alternative implementations of step S2103 in FIG. 2 and step S3103 in FIG. 3A and other related portions of the embodiments described in FIG. 2 and FIG. 3A, and will not be further described here.
Step S3504: obtaining the first information.

Alternative implementations of step S3504 can be found in the alternative implementations of step S2104 in FIG. 2 and step S3104 in FIG. 3A and other related portions of the embodiments described in FIG. 2 and FIG. 3A, and will not be further described here.
Step S3505: sending the fifth information.

Alternative implementations of step S3505 can be found in the alternative implementations of step S2108 in FIG. 2 and step S3108 in FIG. 3A and other related portions of the embodiments described in FIG. 2 and FIG. 3A, and will not be further described here.

In some embodiments, at least one of steps S3501 to S3505 may be performed. For example, step S3505 can be implemented as an independent embodiment; step S3504+step S3505 can be implemented as an independent embodiment; step S3501+step S3504+step S3505 can be implemented as an independent embodiment; and step S3501+step S3502+step S3504+step S3505 can be implemented as an independent embodiment; but the present disclosure is not limited thereto.

In some embodiments, steps S3501, S3502, S3503, and S3504 are optional, and one or more of these steps may be omitted or replaced in different embodiments.

In the embodiments of the present disclosure, steps S3504 and S3505 can be combined with step S3105 in FIG. 3A; steps S3501, S3504, and S3505 can be combined with steps S3105 and S3106 in FIG. 3A; and steps S3501, S3504, and S3505 can be combined with steps S3105, S3106, and S3107 in FIG. 3A.

FIG. 3F is a flow chart illustrating a communication method according to an embodiment of the present disclosure. As shown in FIG. 3F, the embodiments of the present disclosure relate to a communication method performed by the terminal 101, including:
Step S3601: receiving first information.

In some embodiments, the first information is configured to instruct the terminal to send a first parameter multiple times, the first parameter is configured to evaluate the performance of a channel state information (CSI) compression model.

In some embodiments, downlink control information (DCI) is received, and the DCI includes the first information.

In some embodiments, second information is received, and the second information includes at least one of the following:
information indicating the number of transmissions;

In some embodiments, the first information is received while a downlink reference signal is in an active state, where the downlink reference signal is used for channel measurement and is semi-persistent.

Information indicating a quantization method, the quantization method being configured to quantize the first parameter;
information indicating a transmission mode, the transmission mode being a first mode or a second mode, the first mode corresponding to wideband measurement and the second mode corresponding to subband measurement;
information indicating a time domain interval, the time domain interval being a time domain interval between two consecutive transmissions of the first parameter;
information indicating a subband identifier; or information indicating the first parameter.

In some embodiments, receiving the second information includes receiving radio link control (RRC) information, the RRC information including the second information.

In some embodiments, receiving third information, where the third information includes information indicating the time-frequency resource and the period of a downlink reference signal, and the downlink reference signal is used for channel measurement; and determining multiple timings based on the time-frequency resource and the period of the downlink reference signal, the timings being timings for receiving the downlink reference signal.

In some embodiments, the third information includes information indicating enabling a time limit for channel measurement.

The first parameter is determined based on one of the multiple timings, where the one timing is earlier than a first time and is closest to the first time among the multiple timings, and the first time is a time when the first parameter is sent.

In some embodiments, the third information includes information indicating disabling a time limit for channel measurement.

The first parameter is determined based on the multiple timings, or the first parameter is determined based on one of the multiple timings.

The one timing is earlier than a first time and is closest to the first time among the multiple timings, and the first time is a time when the first parameter is sent.

In some embodiments, fourth information is received, and the fourth information is used to configure a CSI reference resource.

The one timing is no later than the CSI reference resource.
Step S3602: sending the first parameter multiple times.

In some embodiments, if the second information does not include information indicating a time domain interval, the first parameter is sent multiple times according to the period.

In some embodiments, the interval between a first time and a second time is greater than a first duration, and the interval between the first time and a third time is greater than a second duration. The first time is a time when the first parameter is sent, the second time is an end time of receiving the first information, the third time is an end time of a downlink reference signal, and the downlink reference signal is used for channel measurement.

In some embodiments, the first duration is greater than or equal to the processing delay for decoding the DCI and preparing the physical uplink shared channel (PUSCH), and the second duration is greater than or equal to the processing delay for calculating the CSI.

In some embodiments, different first parameters correspond to different processing delays.

In some embodiments, the first parameter includes at least one of the following:
ground-truth CSI; or
a second parameter indicating a degree of similarity.

In some embodiments, the second parameter includes at least one of the following:
a degree of similarity based on a CSI compression model, where the CSI compression model is in use;
a degree of similarity based on a CSI compression model that is not in use;
a degree of similarity of a codebook-based CSI processing method;
SGCS; GSC; NMSE.

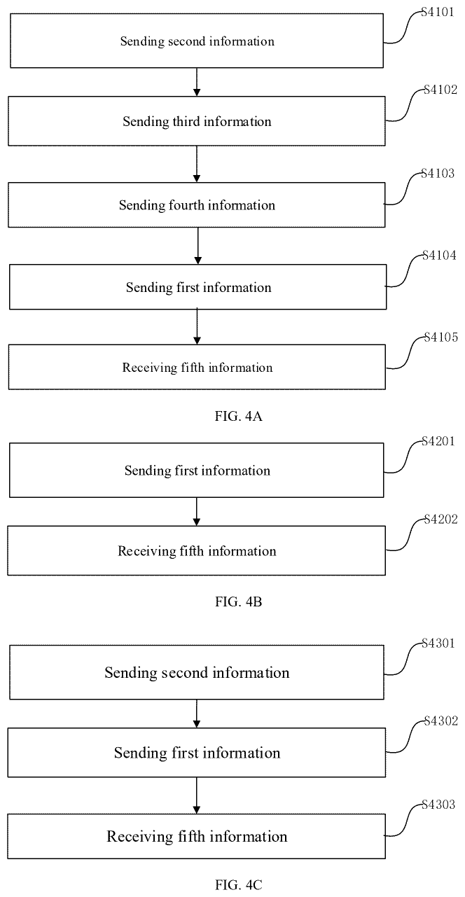

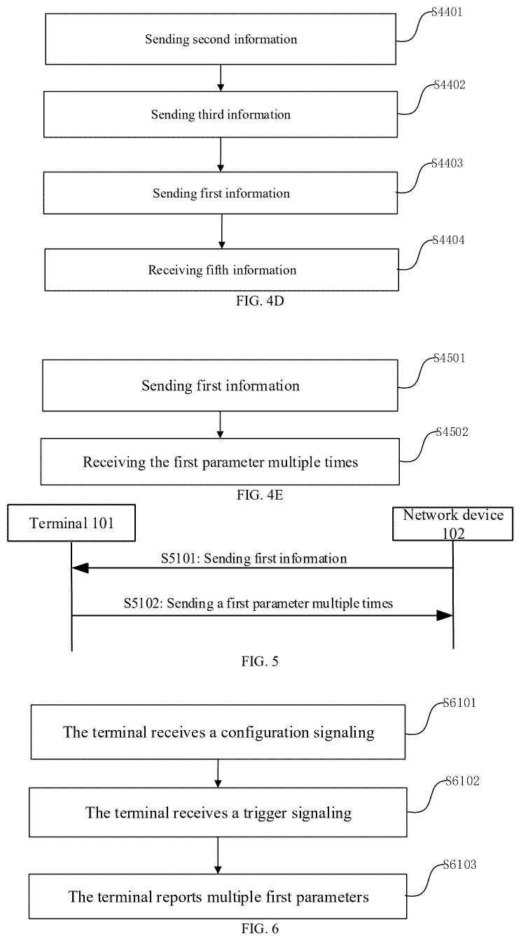

FIG. 4A is a flow chart illustrating a communication method according to an embodiment of the present disclosure. As shown in FIG. 4A, an embodiment of the present disclosure relates to a communication method performed by the network device 102. The method includes:
Step S4101: sending second information.

Alternative implementations of step S4101 can be found in the alternative implementations of step S2101 in FIG. 2 and other related portions of the embodiments described in FIG. 2, and will not be further described here.

In some embodiments, the network device 102 sends the second information to the terminal 101, but is not limited thereto. The network device 102 can also send the second information to other entities.

Alternatively, the second information is used by terminal 101 to perform configuration. Alternative implementations thereof can be found in the alternative implementations of step S2101 in FIG. 2 and other related portions of the embodiments described in FIG. 2, and will not be further described here.
Step S4102: sending third information.

Alternative implementations of step S4102 can be found in the alternative implementations of step S2102 in FIG. 2 and other related portions of the embodiments described in FIG. 2, and will not be further described here.

In some embodiments, the network device 102 sends the third information to the terminal 101, but is not limited to thereto. The network device 102 can also send the third information to other entities.

Alternatively, the third information is used by terminal 101 to perform configuration. Alternative implementations thereof can be found in the alternative implementations of step S2102 in FIG. 2 and other related portions of the embodiments described in FIG. 2, and will not be further described here.
Step S4103: sending fourth information.

Alternative implementations of step S4103 can be found in the alternative implementations of step S2103 in FIG. 2 and other related portions of the embodiments described in FIG. 2, and will not be further described here.

In some embodiments, the network device 102 sends the fourth information to the terminal 101, but is not limited to thereto. The network device 102 can also send the fourth information to other entities.

Alternatively, the fourth information is used by terminal 101 to perform configuration. Alternative implementations thereof can be found in the alternative implementations of step S2103 in FIG. 2 and other related portions of the embodiments described in FIG. 2, and will not be further described here.
Step S4104: sending first information.

Alternative implementations of step S4104 can be found in the alternative implementations of step S2104 in FIG. 2 and other related portions of the embodiments described in FIG. 2, and will not be further described here.

In some embodiments, the network device 102 sends the first information to the terminal 101, but is not limited thereto. The network device 102 can also send the first information to other entities.

Alternatively, the first information is used by terminal 101 to perform configuration. Alternative implementations thereof can be found in the alternative implementations of step S2104 in FIG. 2 and other related portions of the embodiments described in FIG. 2, and will not be further described here.
Step S4105: obtaining fifth information.

Alternative implementations of step S4105 can be found in the alternative implementations of step S2108 in FIG. 2 and other related portions of the embodiments described in FIG. 2, and will not be further described here.

In some embodiments, the network device 102 receives the fifth information sent by the terminal 101, but is not limited thereto. The network device 102 may also receive the fifth information sent by other entities.

In some embodiments, the network device 102 obtains the fifth information specified by a protocol.

In some embodiments, the network device 102 obtains the fifth information from an upper layer(s).

In some embodiments, the network device 102 performs process to obtain the fifth information.

In some embodiments, step S4105 is omitted, and the network device 102 autonomously implements the function indicated by the fifth information, or the function is defaulted or set as default.

In some embodiments, at least one of steps S4101 to S4105 may be performed. For example, step S4105 can be implemented as an independent embodiment; step S4104+step S4105 can be implemented as an independent embodiment; step S4101+step S4104+step S4105 can be implemented as an independent embodiment; and step S4101+step S4102+step S4104+step S4105 can be implemented as an independent embodiment; but the present disclosure is not limited thereto.

In some embodiments, any two steps from step S4101 to step S4104 can be swapped in order or performed simultaneously.

In some embodiments, step S4101, step S4102, and step S4103 can be performed simultaneously.

In some embodiments, when step S4101, step S4102, and step S4103 are performed simultaneously, the information in step S4101, step S4102, and step S4103 is sent via the same signaling, for example, RRC signaling.

In some embodiments, steps S4101 to S4104 are optional, and one or more of these steps may be omitted or replaced in different embodiments.

In some embodiments, steps S4101 to S4103 are optional, and one or more of these steps may be omitted or replaced in different embodiments.

FIG. 4B is a flow chart illustrating a communication method according to an embodiment of the present disclosure. As shown in FIG. 4B, the embodiment of the present disclosure relates to a communication method, performed by the terminal 101, including:
Step S4201: obtaining first information.

Alternative implementations of step S4201 can be found in the alternative implementations of step S2104 in FIG. 2 and step S4104 in FIG. 4A and other related portions of the embodiments described in FIG. 2 and FIG. 4A, and will not be further described here.
Step S4202: sending fifth information.

Alternative implementations of step S4202 can be found in the alternative implementations of step S2108 in FIG. 2 and step S4105 in FIG. 4A and other related portions of the embodiments described in FIG. 2 and FIG. 4A, and will not be further described here.

In some embodiments, at least one of steps S4201 and S4202 may be performed. For example, step S4202 may be implemented as an independent embodiment; however, the present disclosure is not limited thereto.

In some embodiments, step S4201 is optional, and one or more of these steps may be omitted or replaced in different embodiments.

In the embodiments of the present disclosure, step S4202 may be combined with step S4101 of FIG. 4A, step S4202 may be combined with step S4102 of FIG. 4A, and step S4202 may be combined with step S4103 of FIG. 3A.

FIG. 4C is a flow chart illustrating a communication method according to an embodiment of the present disclosure. As shown in FIG. 4C, the embodiment of the present disclosure relates to a communication method, performed by the terminal 101, including:
Step S4301: obtaining second information.

Alternative implementations of step S4301 can be found in the alternative implementations of step S2101 in FIG. 2 and step S4101 in FIG. 4A and other related portions of the embodiments described in FIG. 2, FIG. 4A and FIG. 4B, and will not be further described here.
Step S4302: obtaining first information.

Alternative implementations of step S4302 can be found in the alternative implementations of step S2102 in FIG. 2 and step S4102 in FIG. 4A and other related portions of the embodiments described in FIG. 2 and FIG. 4A, and will not be further described here.
Step S4303: sending fifth information.

Alternative implementations of step S4303 can be found in the alternative implementations of step S2108 in FIG. 2 and step S3105 in FIG. 3A and other related portions of the embodiments described in FIG. 2, FIG. 3A and FIG. 3B, and will not be further described here.

In some embodiments, at least one of steps S4301 to S4303 may be performed. For example, step S4303 may be implemented as an independent embodiment; step S4301+step S4303 may be implemented as an independent embodiment; and step S4302+step S4303 may be implemented as an independent embodiment; but the present disclosure is not limited thereto.

In some embodiments, steps S4301 and 4302 are optional, and one or more of these steps may be omitted or replaced in different embodiments.

In the embodiments of the present disclosure, step S4303 may be combined with step S4102 of FIG. 4A; and step S4303 may be combined with step S4103 of FIG. 4A.

FIG. 4D is a flow chart illustrating a communication method according to an embodiment of the present disclosure. As shown in FIG. 4D, the embodiment of the present disclosure relates to a communication method, performed by the terminal 101, including:
Step S4401: obtaining second information.

Alternative implementations of step S4401 can be found in the alternative implementations of step S2101 in FIG. 2 and step S4101 in FIG. 4A and other related portions of the embodiments described in FIG. 2 and FIG. 4A, and will not be further described here.
Step S4402: obtaining third information.

Alternative implementations of step S4402 can be found in the alternative implementations of step S2102 in FIG. 2 and step S4102 in FIG. 4A and other related portions of the embodiments described in FIG. 2 and FIG. 3A, and will not be further described here.
Step S4403: obtaining first information.

Alternative implementations of step S4403 can be found in the alternative implementations of step S2103 in FIG. 2 and step S4103 in FIG. 4A and other related portions of the embodiments described in FIG. 2 and FIG. 3A, and will not be further described here.
Step S4404: sending fifth information.

Alternative implementations of step S4404 can be found in the alternative implementations of step S2108 in FIG. 2 and step S4105 in FIG. 4A and other related portions of the embodiments described in FIG. 2 and FIG. 3A, and will not be further described here.

In some embodiments, at least one of steps S4401 to S4404 can be performed. For example, step S4404 can be implemented as an independent embodiment; step S4403 and step S4404 can be implemented as an independent embodiment; step S4401 and step S4404 can be implemented as an independent embodiment; and step S4402 and step S4404 can be implemented as an independent embodiment, but the present disclosure is not limited thereto.

In some embodiments, steps S4401, S4402, and S4403 are optional, and one or more of these steps may be omitted or replaced in different embodiments.

In the embodiments of the present disclosure, step S4404 may be combined with step S4103 of FIG. 4A.

FIG. 4E is a flow chart illustrating a communication method according to an embodiment of the present disclosure. As shown in FIG. 4E, the embodiment of the present disclosure relates to a communication method, performed by the network device 102, including:
Step S4501: sending first information.

In some embodiments, the first information is configured to instruct a terminal to send a first parameter multiple times, and the first parameter is configured to evaluate the performance of a channel state information (CSI) compression model.

In some embodiments, the first information is sent when a downlink reference signal is in an active state, where the downlink reference signal is used for channel measurement and is semi-persistent.

In some embodiments, downlink control information (DCI) is sent, and the DCI includes the first information.

In some embodiments, second information is sent, and the second information includes at least one of the following:
information indicating the number of transmissions;
information indicating a timer;
information indicating a quantization method, the quantization method being configured to quantize the first parameter;
information indicating a transmission mode, the transmission mode being a first mode or a second mode, the first mode corresponding to wideband measurement and the second mode corresponding to subband measurement;
information indicating a time domain interval, the time domain interval being a time domain interval between two consecutive transmissions of the first parameter;
information indicating a subband identifier; or
information indicating the first parameter.

In some embodiments, radio link control (RRC) information is sent, and the RRC information includes the second information.

In some embodiments, third information is sent, and the third information includes information indicating the time-frequency resource and the period of a downlink reference signal used for channel measurement;

The time-frequency resource and the period of the downlink reference signal are used to determine multiple timings, the timings being timings for receiving the downlink reference signal.

In some embodiments, the third information includes information indicating enabling a time limit for channel measurement.

The first parameter is determined based on one of the multiple timings, where the one timing is earlier than a first time and is closest to the first time among the multiple timings, and the first time is a time when the first parameter is sent.

In some embodiments, the third information includes information indicating disabling a time limit for channel measurement.

The first parameter is determined based on the multiple timings, or the first parameter is determined based on one of the multiple timings.

The one timing is earlier than a first time and is closest to the first time among the multiple timings, and the first time is a time when the first parameter is sent.

In some embodiments, fourth information is sent, and the fourth information is used to configure a CSI reference resource; the one timing is no later than the CSI reference resource.
Step S4502: receiving the first parameter multiple times.

In some embodiments, if the second information does not include information indicating a time domain interval, the first parameter is received multiple times according to the period.

In some embodiments, the interval between a first time and a second time is greater than a first duration, and the interval between the first time and a third time is greater than a second duration. The first time is a time when the first parameter is sent, the second time is an end time of receiving the first information, the third time is an end time of a downlink reference signal, and the downlink reference signal is used for channel measurement.

In some embodiments, the first duration is greater than or equal to the processing delay for decoding the DCI and preparing the physical uplink shared channel (PUSCH), and the second duration is greater than or equal to the processing delay for calculating the CSI.

In some embodiments, different first parameters correspond to different processing delays.

In some embodiments, the first parameter includes at least one of the following:
ground-truth CSI; or
a second parameter indicating a degree of similarity.

In some embodiments, the second parameter includes at least one of the following:
a degree of similarity based on a CSI compression model, where the CSI compression model is in use;
a degree of similarity based on a CSI compression model that is not in use;
a degree of similarity of a codebook-based CSI processing method;
a square of generalized cosine similarity (SGCS);
a generalized cosine similarity (GSC); or
a normalized mean square error (NMSE).

FIG. 5 is a flow chart illustrating a communication method according to an embodiment of the present disclosure. As shown in FIG. 5, the embodiment of the present disclosure relates to a communication method for use in a communication system 100. The method includes:
Step S5101: the network device 102 sends first information to the terminal 101.

In some embodiments, the first information instructs the terminal to send a first parameter multiple times, where the first parameter is configured to evaluate the performance of a channel state information (CSI) compression model.

In some embodiments, the terminal 101 receives the first information.

Alternative implementations of step S5101 can be found in the alternative implementations of step S2104 in FIG. 2, step S3104 in FIG. 3A and step S4104 in FIG. 4A and other related portions of the embodiments described in FIG. 2, FIG. 3A and FIG. 4A, and will not be further described here.
Step S5102: the terminal 101 sends the first parameter multiple times to the network device 102.

In some embodiments, the network device 102 receives the first parameter multiple times.

Alternative implementations of step S5102 can be found in the alternative implementations of step S2108 in FIG. 2, step S3108 in FIG. 3A and step S4105 in FIG. 4A and other related portions of the embodiments described in FIG. 2, FIG. 3A and FIG. 4A, and will not be further described here.

In some embodiments, the above method may include the methods described in the above embodiments on the communication system side, the terminal side, the network device side, etc., which are not further described here.

FIG. 6 is a flow chart illustrating a communication method according to an embodiment of the present disclosure. As shown in FIG. 6, the embodiment of the present disclosure relates to a communication method for use in a communication system 100. The method includes:
Step S6101: the terminal 101 receives a configuration signaling.

In some embodiments, the configuration signaling is RRC signaling.

In some embodiments, the configuration signaling includes information indicating a first parameter.

In one example, the configuration signaling includes information indicating ground-truth CSI, and the terminal 101 learns that the first parameter to be sent is the ground-truth CSI.

In one example, the configuration signaling includes information indicating SGCS, and the terminal 101 learns that the first parameter to be sent is SGCS.

In some embodiments, the configuration signaling includes information indicating the number of transmissions.

Alternatively, the number of transmissions is the number of consecutive transmissions of multiple first parameters.

In some embodiments, the configuration signaling includes information indicating a quantization method.

Alternatively, the quantization method is configured to quantize the first parameter.

In some embodiments, the configuration signaling includes information indicating a transmission mode, where the transmission mode is a first mode or a second mode, the first mode corresponds to wideband measurement, and the second mode corresponds to subband measurement.

Alternatively, the first mode corresponds to sending a single first parameter for the entire measurement bandwidth.

Alternatively, the second mode corresponds to sending a single first parameter for each subband.

In some embodiments, the configuration signaling includes information indicating a transmission mode, and if the transmission mode is the second mode, the configuration signaling further includes information indicating at least one subband.

Alternatively, the at least one subband is a subband on which the terminal 101 performs measurement.

Alternatively, the configuration signaling further includes a subband division mode.

Alternatively, the subband division mode includes the number of resource blocks included in each subband.

In some embodiments, the configuration signaling includes information indicating a transmission period.
Step S6102: the terminal 101 receives a trigger signaling.

In some embodiments, the trigger signaling is DCI.

In some embodiments, the DCI is configured to dynamically trigger the terminal 101 to send multiple first parameters.
Step S6103: the terminal 101 sends multiple first parameters.

In some embodiments, the first parameters are configured to monitor the performance of the AI CSI compression model.

In some embodiments, the terminal 101 sends multiple first parameters upon a single trigger.

In some embodiments, the first parameter is ground-truth CSI, or a second parameter.

Alternatively, the second parameter is a performance monitoring indicator calculated by the terminal 101.

Alternatively, the ground-truth CSI is a floating point number, or is represented in a format similar to eType II.

Alternatively, the performance monitoring indicator calculated by the terminal 101 is at least one of the following:
SGCS; GCS; NMSE.

In some embodiments, if the trigger signaling includes information indicating a quantization method, the terminal 101 performs quantization according to the quantization method.

In some embodiments, if the trigger signaling does not include information indicating a quantization method, the terminal 101 performs quantization according to a preset quantization method or a default quantization method.

In some embodiments, the terminal 101 does not want the configured first period to be greater than the transmission period, where the first period is the period of the downlink reference signal.

In some embodiments, between steps S6102 and S6103, the terminal determines which downlink reference signal (e.g., CSI-RS) to start measurement from.

In one example, measurement starts from the first CSI-RS after receiving DCI and exceeding the DCI processing delay.

For example, if DCI is received in slot n, and x is the processing delay, then the terminal 101 considers the first CSI-RS after slot n+x to be the downlink reference signal from which measurement starts. The unit of x can be symbol, slot, or half-slot.

In some embodiments, the interval between the time when the configuration signaling is received and the time when the first parameter is first sent is greater than the processing delay.

In some embodiments, different first parameters correspond to different processing delays.

The following describes five embodiments.

### Embodiment 1

The network device 102 sends CSI report configuration information (CSIreportconfiguration) to the terminal 101. The CSI report configuration information includes parameter group A, parameter group B, parameter group C, parameter group D, parameter group E, and parameter group F.

Parameter group A is a reporting configuration (reportingsetting), which includes a report configuration identifier (reportconfigID). The report configuration identifier (reportconfigID) indicates 2.

Parameter group B is a resource configuration (resourcesetting), which includes CSI resource configuration #1 (CSI-ResourceConfig #1). CSI resource configuration #1 (CSI-ResourceConfig #1) corresponds to a periodic CSI-RS with a period of 5 time slots.

Parameter group C is a report configuration type (reportConfigtype), which indicates aperiodic. The list of send time slot offsets corresponding to aperiodic transmission includes {1, 4, 6,8}.

Parameter group D is a number of transmissions (NrofReport), which indicates 10.

Parameter group E is a quantity of report (ReportQuantity), which indicates ground-truth CSI (groundTruthCSI), indicates the quantization method as eTypeII type, and indicates the corresponding eTypeII coefficients.

Parameter group F is a report frequency domain configuration (ReportFreqConfiguration), which includes ground-truth CSI format indicator (groundTruthCSI-FormatIndicator). The ground-truth CSI format indicator (groundTruthCSI-FormatIndicator) indicates ground-truth CSI of the wideband (widebandGroundTruthCSI).

The network device 102 sends a CSI-aperiodic trigger state list (CSI-AperiodicTriggerStateList) to the terminal 101, the content of which is {1, 2, 3, 4}, i.e., CSI-AperiodicTriggerStateList={1, 2, 3, 4}.

The network device 102 sends a CSI-Aperiodic Trigger State (CSI-AperiodicTriggerState) to the terminal 101. When the content of the CSI-Aperiodic Trigger State is 1, i.e., CSI-AperiodicTriggerState=1, it corresponds to a report configuration ID (reportConfigID) of 2, i.e., reportConfigID=2, indicating that the CSI corresponding to reportConfigID=2 is used to send the configuration information.

The terminal 101 receives DCI in time slot 2. The CSI request (CSIrequest) field in the DCI indicates 1, i.e., indicating triggering aperiodic transmission, and the offset field in the DCI indicates four time slots. Therefore, based on the time of DCI reception (i.e., time slot 2) and the four time slots indicated by the offset field, the terminal 101 determines the time of the first transmission to be time slot 6.

Based on parameter groups B and C, the terminal 101 determines to use a five-time slot period, with transmissions occurring every five time slots. Specifically, the first transmission occurs in time slot 6, the second transmission occurs in time slot 11, and so on.

Based on parameter group D, the terminal 101 determines that the number of transmissions is 10. Specifically, the tenth transmission is performed in time slot 51, and after the tenth transmission, the transmission is completed.

Based on parameter group E, the terminal 101 determines that the ground-truth CSI is sent during each transmission.

Based on parameter group F, the terminal 101 determines that the sent ground-truth CSI is for wideband.

### Embodiment 2

The network device 102 sends CSI report configuration information (CSIreportconfiguration) to the terminal 101. The CSI report configuration information includes parameter group A, parameter group B, parameter group C, parameter group D, parameter group E, and parameter group F.

Parameter group A is a reporting configuration (reportingsetting), which includes a report configuration identifier (reportconfigID). The report configuration identifier (reportconfigID) indicates 2.

Parameter group B is a resource configuration (resourcesetting), which includes CSI resource configuration #1 (CSI-ResourceConfig #1). The CSI resource configuration #1 (CSI-ResourceConfig #1) corresponds to a periodic CSI-RS with a period of 5 time slots.

Parameter group C is a report configuration type (reportConfigtype), which indicates aperiodic. The list of send time slot offsets corresponding to aperiodic transmission includes {1, 4, 6,8}.

Parameter group D is a number of transmissions (NrofReport), which indicates 10.

Parameter group E is a quantity of report (ReportQuantity), which indicates ground-truth CSI (groundTruthCSI), indicates the quantization method as eTypeII type, and indicates the corresponding eTypeII coefficients.

Parameter group F is a report frequency domain configuration (ReportFreqConfiguration), which includes ground-truth CSI format indicator (groundTruthCSI-FormatIndicator). The ground-truth CSI format indicator (groundTruthCSI-FormatIndicator) indicates ground-truth CSI of wideband (widebandGroundTruthCSI).

The network device 102 sends a CSI-Aperiodic Trigger State List (CSI-AperiodicTriggerStateList) to the terminal 101, the content of which is {1, 2, 3, 4}, i.e., CSI-AperiodicTriggerStateList={1, 2, 3, 4}.

The network device 102 sends a CSI-Aperiodic Trigger State (CSI-AperiodicTriggerState) to the terminal 101. When the content of the CSI-Aperiodic Trigger State is 1, i.e., CSI-AperiodicTriggerState=1, it corresponds to a report configuration ID (reportConfigID) of 2, i.e., reportConfigID=2.

The terminal 101 receives DCI in time slot 2. The CSI request (CSIrequest) field in the DCI indicates 1, i.e., indicating triggering aperiodic transmission with CSI-AperiodicTriggerState=1. This indicates that the CSI corresponding to reportConfigID=2 is used to send configuration information.

The offset field of the DCI indicates 4 time slots. Therefore, based on the time of receiving the DCI, i.e., time slot 2, and the four time slots indicated by the offset field, the terminal 101 determines that the first transmission time is time slot 6.

Based on parameter group E, the terminal 101 determines to send ground-truth CSI during each transmission.

Based on parameter group F, the terminal 101 determines that the sent ground-truth CSI is for wideband.

Based on parameter groups B and C, the terminal 101 determines to use a five-time slot period, with transmissions occurring every five time slots. Specifically, the first transmission occurs in time slot 6, the second transmission occurs in time slot 11, and so on.

Based on parameter group D, the terminal 101 determines that the number of transmissions is 10. Specifically, the tenth transmission is performed in time slot 51, and after the tenth transmission, transmission is completed.

### Embodiment 3

The network device 102 sends CSI report configuration information (CSIreportconfiguration) to the terminal 101. The CSI report configuration information includes parameter group A, parameter group B, parameter group C, parameter group D, parameter group E, parameter group F, and parameter group G.

Parameter group A is a reporting configuration (reportingsetting), which includes a report configuration identifier (reportconfigID). The content of the report configuration identifier (reportconfigID) differs from that of parameter group A in Embodiment 1 and indicates 3.

Parameter group B is a resource setting (resource setting), which includes CSI resource configuration #1 (CSI-ResourceConfig #1). The content of the CSI resource configuration #1 (CSI-ResourceConfig #1) is the same as that of the CSI resource configuration #1 (CSI-ResourceConfig #1) in Embodiment 1. The CSI resource configuration #1 (CSI-ResourceConfig #1) corresponds to a periodic CSI-RS with a period of 5 time slots.

Parameter group C is a report configuration type (reportConfigtype). The content of parameter group C is the same as that of parameter group C in Embodiment 1 and indicates aperiodic. The list of send slot offsets corresponding to aperiodic transmission includes {1, 4, 6, 8}.

Parameter group D is a number of transmissions (NrofReport). The content of parameter group D is the same as that of parameter group D in Embodiment 1 and indicates 10.

Parameter group E is a quantity of report (ReportQuantity). The content of parameter group E is different from that of parameter group E in Embodiment 1. Parameter group E indicates SGCS based on AI CSI compression (AISGCS) and SGCS based on codebook (codebookSGCS). The codebook type (codebook Type) is typeII-r16.

Parameter group F is a report frequency domain configuration (ReportFreqConfiguration), which includes ground-truth CSI format indicator (groundTruthCSI-FormatIndicator). The content of the ground-truth CSI format indicator (groundTruthCSI-FormatIndicator) in parameter group F differs from that of the ground-truth CSI format indicator (groundTruthCSI-FormatIndicator) in Embodiment 1. The ground-truth CSI format indicator (groundTruthCSI-FormatIndicator) in parameter group F indicates the ground-truth CSI of subband.

Parameter group G is a ground-truth CSI-reporting band (groundTruthCSI-reportingBand). Parameter group G indicates subband 4 (subband4).

The network device 102 sends a CSI-Aperiodic Trigger State List (CSI-AperiodicTriggerStateList) to the terminal 101, the content of which is {1, 2, 3, 4}, i.e., CSI-AperiodicTriggerStateList={1, 2, 3, 4}.

The network device 102 sends a CSI-Aperiodic Trigger State (CSI-AperiodicTriggerState) to the terminal 101. When the content of the CSI-Aperiodic Trigger State is 2, i.e., CSI-Aperiodic TriggerState=2, it corresponds to a report configuration ID (reportConfigID) of 3, i.e., reportConfigID=3.

The terminal 101 receives DCI in time slot 2. The CSI request (CSIrequest) field in the DCI indicates 1, i.e., indicating triggering aperiodic transmission. This indicates the CSI corresponding to reportConfigID=3 is used to send configuration information. The offset field in the DCI indicates 4 time slots. Therefore, based on the time of DCI reception, i.e., slot 2, and the four slots indicated by the offset field, the terminal 101 determines that the first transmission time is slot 6.

Based on parameter group E, the terminal 101 determines that both the SGCS based on AI CSI compression and the codebook-based SGCS are sent during each transmission.

Based on parameter group F, the terminal 101 determines that the sent ground-truth CSI is for subband 4.

Based on parameter groups B and C, the terminal 101 determines to use a five-time slot period, with transmissions occurring every five slots. Specifically, the first transmission occurs in slot 6, the second transmission occurs in slot 11, and so on.

Based on parameter group D, the terminal 101 determines that the number of transmissions is 10. Specifically, the tenth transmission is performed in time slot 51, and after the tenth transmission, the transmission is completed.

### Embodiment 4

The network device 102 sends CSI report configuration information (CSIreportconfiguration) to the terminal 101. The CSI report configuration information includes parameter group A, parameter group B, parameter group C, parameter group D, parameter group E, parameter group F, parameter group G, and parameter group H.

Parameter group A, parameter group B, parameter group C, parameter group D, parameter group E, parameter group F, and parameter group G are the same as parameter group A, parameter group B, parameter group C, parameter group D, parameter group E, parameter group F, and parameter group G in Embodiment 2.

Parameter group H is a timer length (timerlength), which indicates 40 milliseconds.

The network device 102 sends a CSI aperiodic trigger state list (CSI-AperiodicTriggerStateList) to the terminal 101. The content of the list is {1, 2, 3, 4}, i.e., CSI-AperiodicTriggerStateList={1, 2, 3, 4}.

The network device 102 sends a CSI-Aperiodic Trigger State (CSI-AperiodicTriggerState) to the terminal 101. When the content of the CSI-Aperiodic Trigger State is 2, i.e., CSI-Aperiodic TriggerState=2, it corresponds to a reporting configuration ID (reportConfigID) of 3, i.e., reportConfigID=3.

The terminal 101 receives DCI in time slot 2. The CSI request (CSIrequest) field in the DCI indicates 2, indicating triggering aperiodic transmission with CSI-AperiodicTriggerState=2. This indicates that the CSI corresponding to reportConfigID=3 is used to send the configuration information. The offset field in the DCI indicates 4 time slots. Therefore, based on the time of receiving the DCI (time slot 2) and the 4 time slots indicated by the offset field, the terminal 101 determines that the first transmission time is time slot 6.

Based on parameter group E, the terminal 101 determines to send SGCS based on AI CSI compression and a codebook-based SGCS in each transmission.

Based on parameter group F, the terminal 101 determines that the sent ground-truth CSI is for subband 4.

Based on parameter groups B and C, the terminal 101 determines to use a five-time slot period, with transmissions occurring every five time slots. Specifically, the first transmission occurs in time slot 6, the second transmission occurs in time slot 11, and so on.

The terminal 101 determines the number of transmissions to be 10 based on parameter group D, and the timer length to be 40 milliseconds based on parameter group H. The terminal 101 starts the timer when sending for the first time in time slot 6. After the ninth transmission in time slot 26, the timer expires, and the terminal 101 stops sending. Thus, the terminal 101, limited by the timer, performs a total of nine transmissions.

### Embodiment 5

The network device 102 sends CSI report configuration information (CSIreportconfiguration) to the terminal 101. The CSI report configuration information includes parameter group A, parameter group B, parameter group C, parameter group D, parameter group E, parameter group F, parameter group G, and parameter group I.

Parameter group A, parameter group B, parameter group C, parameter group D, parameter group E, parameter group F and parameter group G are the same as those in Embodiment 2.

Parameter group H is a report interval (reportinterval), indicating 10 time slots.

The network device 102 sends a CSI-Aperiodic Trigger State List (CSI-AperiodicTriggerStateList) to the terminal 101, the content of which is {1, 2, 3, 4}, i.e., CSI-AperiodicTriggerStateList={1, 2, 3, 4}.

The network device 102 sends a CSI-Aperiodic Trigger State (CSI-AperiodicTriggerState) to the terminal 101. When the content of the CSI-Aperiodic Trigger State is 2, i.e., CSI-AperiodicTriggerState=2, it corresponds to a reporting configuration ID (reportConfigID) of 3, i.e., reportConfigID=3.

The terminal 101 receives DCI in time slot 2. The CSI request (CSIrequest) field in the DCI indicates 2, indicating triggering aperiodic transmission with CSI-AperiodicTriggerState=2. This indicates that the CSI corresponding to reportConfigID=3 is used to send configuration information. The offset field in the DCI indicates 4 time slots. Therefore, based on the time of receiving the DCI (time slot 2) and the 4 time slots indicated by the offset field, the terminal 101 determines that the first transmission time is time slot 6.

Based on parameter group E, the terminal 101 determines to send both SGCS based on AI CSI compression and a codebook-based SGCS in each transmission.

Based on parameter group F, the terminal 101 determines that the sent ground-truth CSI is for subband 4.

The terminal 101 determines the number of transmissions to be 10 based on parameter group D and the transmission interval to be 10 time slots based on parameter group H. Therefore, the terminal 101 starts a timer when sending for the first time in time slot 6, sends for the second time in time slot 16, and so on, until the tenth transmission in time slot 96. After the tenth transmission, the transmission is completed.

Since the transmission interval is 10 time slots, which is twice the period of the reference signal corresponding to parameter group B, one of the following three schemes can be adopted according to the indication of parameter group X:

First, SGCS based on AI CSI compression and SGCS based on codebook in each transmission correspond to the average of two measurement results;

Second, parameter group X indicates a time-domain limitation, and SGCS based on AI CSI compression and SGCS based on codebook in each transmission correspond to the measurement result most recent to the transmission time;

Third, the SGCS based on AI CSI compression and SGCS based on codebook in each transmission correspond to two measurement results. In this case, the offset of the first transmission must be large enough, i.e., the offset must be no less than twice the period of the downlink reference signal, so that the first transmission corresponds to two CSI measurements.

The present disclosure also provides a device for implementing any of the above methods. For example, a device is provided that includes units or modules for implementing the steps performed by the terminal in any of the above methods. For another example, another device is provided that includes units or modules for implementing the steps performed by the network device (e.g., the access network device, the core network functional node, the core network device, etc.) in any of the above methods.

It should be understood that the division of units or modules in the above device is only a logical functional division. In actual implementation, they can be fully or partially integrated into a single physical entity, or they can be physically separated. Furthermore, the units or modules in the device can be implemented in the form of a processor calling software: for example, the device includes a processor connected to a memory containing instructions, and the processor calls the instructions stored in the memory to implement any of the above methods or to implement the functions of the units or modules of the device. The processor is, for example, a general-purpose processor, such as a Central Processing Unit (CPU) or a microprocessor, and the memory is either internal or external to the device. Alternatively, the units or modules in the device can be implemented in the form of hardware circuits. The functions of some or all of the units or modules can be implemented through the design of the hardware circuits, which can be understood as one or more processors. For example, in one implementation, the hardware circuit is an application-specific integrated circuit (ASIC), and the functions of some or all of the units or modules are implemented through the design of the logical relationships between the components within the circuit. In another implementation, the hardware circuit can be implemented using a programmable logic device (PLD), such as a Field Programmable Gate Array (FPGA), which can include a large number of logic gates. The connection relationships between the logic gates are configured through a configuration file, thereby implementing the functions of some or all of the units or modules. All units or modules of the above devices may be implemented entirely by a processor calling software, or entirely by hardware circuits, or partially by a processor calling software and the rest by hardware circuits.

In the embodiments of the present disclosure, a processor is a circuit capable of signal processing. In one implementation, the processor may be a circuit capable of reading and executing instructions, such as a central processing unit (CPU), a microprocessor, a graphics processing unit (GPU) (which can be understood as a type of microprocessor), or a digital signal processor (DSP). In another implementation, the processor may implement certain functions through the logical relationships of hardware circuits, where the logical relationships of the aforementioned hardware circuits are fixed or reconfigurable. For example, the processor may be a hardware circuit implemented as an application-specific integrated circuit (ASIC) or a programmable logic device (PLD), such as an FPGA. In a reconfigurable hardware circuit, the process of the processor loading a configuration file to implement the hardware circuit configuration can be understood as the process of the processor loading instructions to implement the functions of some or all of the above units or modules. Alternatively, it may be a hardware circuit designed for artificial intelligence, which can be understood as an ASIC, such as a neural network processing unit (NPU), a tensor processing unit (TPU), or a deep learning processing unit (DPU), etc.

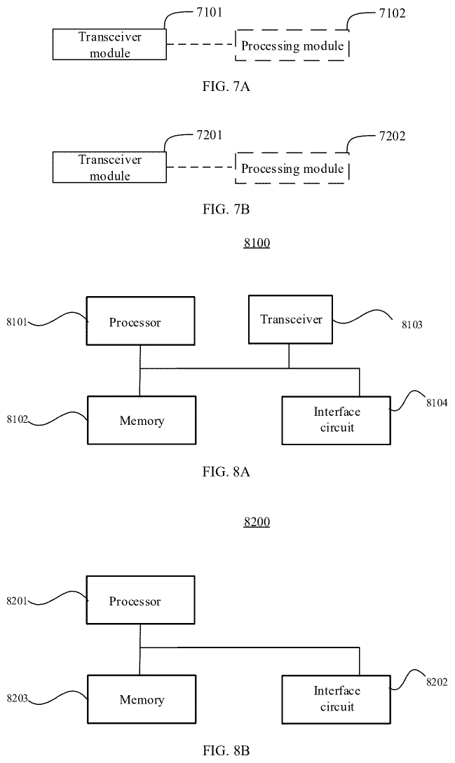

FIG. 7A is a schematic diagram of a structure of a first communication device provided in an embodiment of the present disclosure. As shown in FIG. 7A, the first communication device includes a transceiver module 7101. Alternatively, the transceiver module 7101 is configured to execute steps related to the sending and receiving methods performed by the network device 102 in any of the above methods, which are not described in detail here. Alternatively, the first communication device 7100 further includes a processing module 7102. The processing module 7102 is configured to execute steps related to processing unrelated to sending and receiving performed by the terminal 101 in any of the above methods, which are not described in detail here.

FIG. 7B is a schematic diagram of a structure of a second communication device provided in an embodiment of the present disclosure. As shown in FIG. 7B, the second communication device includes a transceiver module 7201. Alternatively, the transceiver module 7201 is configured to execute the steps related to the sending and receiving methods performed by the terminal 101 in any of the above methods, which are not described in detail here. Alternatively, a processing module 7202 is also included. The processing module 7202 is configured to execute the steps related to processing unrelated to sending and receiving performed by the terminal 101 in any of the above methods, which are not described in detail here.

FIG. 8A is a schematic diagram of a structure of a communication device 8100 provided in an embodiment of the present disclosure. The communication device 8100 can be a network device (e.g., an access network device, a core network device, etc.), a terminal (e.g., a user equipment), or a chip, a chip system, or a processor that supports a network device implementing any of the above methods, or a chip, a chip system, or a processor that supports a terminal implementing any of the above methods. The communication device 8100 can be configured to implement the methods described in the above method embodiments. For details, please refer to the description of the above method embodiments.

As shown in FIG. 8A, the communication device 8100 includes one or more processors 8101. The processor 8101 can be a general-purpose processor or a dedicated processor, such as a baseband processor or a central processing unit (CPU). A baseband processor can be configured to process communication protocols and communication data, while a CPU can be configured to control a communication device (e.g., a base station, a baseband chip, a terminal device, a terminal device chip, a DU or a CU, etc.), execute programs, and process program data. The processor 8101 is configured to invoke instructions to cause the communication device 8100 to perform any of the above methods.

In some embodiments, the communication device 8100 further includes one or more memories 8102 for storing instructions. Alternatively, all or part of the memory 8102 may be located external to the communication device 8100.

In some embodiments, the communication device 8100 further includes one or more transceivers 8103. When the communication device 8100 includes one or more transceivers 8103, the communication steps such as sending and receiving in the above methods are performed by the transceiver 8103, while the other steps are performed by the processor 8101.

In some embodiments, the transceiver may include a receiver and a transmitter, which may be separate or integrated. Alternatively, terms such as transceiver, transceiver unit, transceiver, and transceiver circuit are interchangeable; terms such as transmitter, transmitting unit, sender, sending circuit, and transmitting circuit are interchangeable; and terms such as receiver, receiving unit, receiver machine, and receiving circuit are interchangeable.

Alternatively, the communication device 8100 further includes one or more interface circuits 8104. The interface circuit 8104 is connected to the memory 8102 and can be configured to receive signals from the memory 8102 or other devices, and can be configured to send signals to the memory 8102 or other devices. For example, the interface circuit 8104 can read instructions stored in the memory 8102 and send the instructions to the processor 8101.

The communication device 8100 described in the above embodiments can be a network device or a terminal, but the scope of the communication device 8100 described in the present disclosure is not limited thereto, and the structure of the communication device 8100 may not be limited to FIG. 8A. The communication device can be an independent device or part of a larger device. For example, the communication device may be: (1) an independent integrated circuit IC, or a chip, or a chip system or subsystem; (2) a collection of one or more ICs, alternatively, the above IC collection may further include a storage component for storing data and programs; (3) an ASIC, such as a modem; (4) a module that can be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc.; (6) others, etc.

FIG. 8B is a schematic diagram of a structure of a chip 8200 provided in an embodiment of the present disclosure. For the case where the communication device 8100 can be a chip or a chip system, the schematic diagram of the structure of the chip 8200 shown in FIG. 8B can be referred to, but is not limited to thereto. The chip 8200 includes one or more processors 8201, and the processor 8201 is configured to call instructions so that the chip 8200 executes any of the above methods.

In some embodiments, the chip 8200 further includes one or more interface circuits 8202 connected to the memory 8203. The interface circuit 8202 can be configured to receive signals from the memory 8203 or other devices, or to send signals to the memory 8203 or other devices. For example, the interface circuit 8202 can read instructions stored in the memory 8203 and send these instructions to the processor 8201. Alternatively, the terms such as interface circuit, interface, transceiver pin, and transceiver, etc. are interchangeable.

In some embodiments, the chip 8200 further includes one or more memories 8203 for storing instructions. Alternatively, all or part of the memory 8203 may be located external to the chip 8200.

The present disclosure also provides a storage medium storing instructions. When these instructions are executed on the communication device 8100, the communication device 8100 performs any of the above methods. Alternatively, the storage medium is an electronic storage medium. Alternatively, the storage medium is a computer-readable storage medium, but is not limited thereto and may also be a storage medium readable by other devices. Alternatively, the storage medium may be a non-transitory storage medium, but is not limited thereto and may also be a transient storage medium.

The present disclosure also provides a program product that, when executed by the communication device 8100, causes the communication device 8100 to perform any of the above methods. Alternatively, the program product is a computer program product.

The present disclosure also provides a computer program that, when executed on a computer, causes the computer to perform any of the above methods.

1. A communication method, performed by a terminal, comprising:
receiving first information, the first information instructing the terminal to send a first parameter multiple times, the first parameter being configured to evaluate performance of a channel state information (CSI) compression model; and
sending the first parameter multiple times.

2. The method according to claim 1, further comprising:
receiving second information, wherein the second information comprises at least one of:
information indicating a number of transmissions;
information indicating a timer;
information indicating a quantization method configured to quantize the first parameter;
information indicating a transmission mode, wherein the transmission mode is a first mode or a second mode, the first mode corresponds to wideband measurement and the second mode corresponds to subband measurement;
information indicating a time domain interval between two consecutive transmissions of the first parameter;
information indicating a subband identifier; or
information indicating the first parameter.

3. The method according to claim 1, further comprising:
receiving third information, wherein the third information comprises information indicating a time-frequency resource and a period of a downlink reference signal, and the downlink reference signal is used for channel measurement; and
determining multiple timings based on the time-frequency resource and the period of the downlink reference signal, the timings being timings for receiving the downlink reference signal.

4. The method according to claim 3, wherein
the third information comprises information indicating enabling a time limit for channel measurement;
determining the first parameter based on one of the multiple timings, wherein the one timing is earlier than a first time and is closest to the first time among the multiple timings, and the first time is a time when the first parameter is sent, or
the third information comprises information indicating disabling a time limit for channel measurement;
determining the first parameter based on the multiple timings, or determining the first parameter based on one of the multiple timings;
wherein the one timing is earlier than a first time and is closest to the first time among the multiple timings, and the first time is a time when the first parameter is sent.

5. (canceled)

6. The method according to claim 4, further comprising:
receiving fourth information, wherein the fourth information is used to configure a CSI reference resource;
the one timing is no later than the CSI reference resource.

7. The method according to claim 3, wherein sending the first parameter multiple times comprises:
in a case where the second information does not comprise information indicating a time domain interval between two consecutive transmissions of the first parameter, sending the first parameter multiple times according to the period.

8. The method according to claim 1, wherein receiving the first information comprises:
receiving the first information in a case where a downlink reference signal is in an active state, wherein the downlink reference signal is used for channel measurement and is semi-persistent.

9. The method according to claim 1, wherein an interval between a first time and a second time is greater than a first duration, and an interval between the first time and a third time is greater than a second duration, the first time is a time of sending the first parameter, the second time is an end time of receiving the first information, the third time is an end time of a downlink reference signal, and the downlink reference signal is used for channel measurement.

10. The method according to claim 9, wherein the first duration is greater than or equal to a processing delay for decoding downlink control information (DCI) and preparing a physical uplink shared channel (PUSCH), and the second duration is greater than or equal to a processing delay for calculating the CSI.

11. (canceled)

12. The method according to claim 1, wherein receiving the first information comprises receiving downlink control information (DCI), wherein the DCI comprises the first information.

13. The method according to claim 2, wherein receiving the second information comprises:
receiving radio link control (RRC) information, wherein the RRC information comprises the second information.

14. The method according to claim 1, wherein the first parameter comprises at least one of:
ground-truth CSI; or
a second parameter, wherein the second parameter indicates a degree of similarity.

15. The method according to claim 14, wherein the second parameter comprises at least one of:
a degree of similarity based on the CSI compression model that is in use;
a degree of similarity based on a CSI compression model that is not in use;
a degree of similarity of a codebook based CSI processing method;
a square of generalized cosine similarity (SGCS);
a generalized cosine similarity (GSC); or
a normalized mean square error (NMSE).

16. A communication method, performed by a network device, comprising:
sending first information, the first information instructing a terminal to send a first parameter multiple times, the first parameter being configured to evaluate performance of a channel state information (CSI) compression model; and
receiving the first parameter multiple times.

17. The method according to claim 16, further comprising:
sending second information, wherein the second information comprises at least one of:
information indicating a number of transmissions;
information indicating a timer;
information indicating a quantization method configured to quantize the first parameter;
information indicating a transmission mode, wherein the transmission mode is a first mode or a second mode, the first mode corresponds to wideband measurement and the second mode corresponds to subband measurement;
information indicating a time domain interval between two consecutive transmissions of the first parameter;
information indicating a subband identifier; or
information indicating the first parameter.

18. The method according to claim 17, further comprising:
sending third information, wherein the third information comprises information indicating a time-frequency resource and a period of a downlink reference signal, and the downlink reference signal is used for channel measurement;
wherein the time-frequency resource and the period of the downlink reference signal are configured to determine multiple timings, and the timings are timings for receiving the downlink reference signal.

19. The method according to claim 18, wherein
the third information comprises information indicating enabling a time limit for channel measurement;
the first parameter is determined based on one of the multiple timings, wherein the one timing is earlier than a first time and is closest to the first time among the multiple timings, and the first time is a time when the first parameter is sent, or
the third information comprises information indicating disabling a time limit for channel measurement;
the first parameter is determined based on the multiple timings, or the first parameter is determined based on one of the multiple timings;
the one timing is earlier than a first time and is closest to the first time among the multiple timings, and the first time is a time when the first parameter is sent.

20. (canceled)

21. The method according to claim 19, further comprising:
sending fourth information, wherein the fourth information is used to configure a CSI reference resource;
the one timing is no later than the CSI reference resource.

22.-33. (canceled)

34. A communication device, comprising a processor and a memory, wherein
the processor is configured to invoke instructions to cause the communication device to:
receive first information, the first information instructing the terminal to send a first parameter multiple times, the first parameter being configured to evaluate performance of a channel state information (CSI) compression model; and
send the first parameter multiple times.

35.-36. (canceled)

37. A communication device, comprising a processor and a memory, wherein
the processor is configured to invoke instructions to cause the communication device to perform the communication method according to claim 16.
